(19) United States
(12) Patent Application Publication
(10) Pub. No.: US 2017/0300361 A1
(43) Pub. Date: Oct. 19, 2017

(54) EMPLOYING OUT OF ORDER QUEUES FOR BETTER GPU UTILIZATION

(71) Applicant: INTEL CORPORATION, Santa Clara, CA (US)

(72) Inventors: Pavan K. Lanka, Folsom, CA (US); Krzysztof Laskowski, Gdansk (PL); Michal Mrozek, Tczew (PL)

(73) Assignee: INTEL CORPORATION, Santa Clara, CA (US)

(21) Appl. No.: 15/201,496

(22) Filed: Jul. 3, 2016

Related U.S. Application Data
(60) Provisional application No. 62/323,597, filed on Apr. 15, 2016.

(51) Int. Cl. G06F 9/50; G06F 9/48

(52) U.S. Cl. CPC G06F 9/505; G06F 9/4881; G06F 9/5016

(57) ABSTRACT

Methods and apparatus relating to employing out-of-order queues for improved GPU (Graphics Processing Unit) utilization are described. In an embodiment, logic is used to employ out-of-order queues for improved GPU (Graphics Processing Unit) utilization. Other embodiments are also disclosed and claimed.

### CROSS-REFERENCE TO RELATED APPLICATIONS

The present application is related to and claims priority to U.S. Provisional Patent Application No. 62/323,597, entitled “EMPLOYING OUT OF ORDER QUEUES FOR BETTER GPU UTILIZATION” filed Apr. 15, 2016, which is hereby incorporated herein by reference for all purposes and in its entirety.

### FIELD

The present disclosure generally relates to the field of electronics. More particularly, some embodiments relate to employing out-of-order queues for improved GPU (Graphics Processing Unit) utilization.

### BACKGROUND

GPUs are quickly becoming an integral part of computing, whether on stationary or mobile computing systems. Accordingly, efficient implementation of GPUs can have a direct effect on performance, power consumption, etc.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 3, 4, 13, and 15 illustrate block diagrams of embodiments of computing systems, which may be utilized to implement various embodiments discussed herein.

FIGS. 2A-2G illustrate block diagrams and/or flow diagrams, according some embodiments.

FIGS. 5-9 and 11 illustrate various components of processers in accordance with some embodiments.

FIG. 10 illustrates graphics core instruction formats, according to some embodiments.

FIGS. 12A and 12B illustrate graphics processor command format and sequence, respectively, according to some embodiments.

FIG. 14 illustrates a diagram of IP core development according to an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

Generally, GPUs (Graphics Processing Units) can utilize highly parallel architectures. The parallel architecture allows for processing of large sets of data in a very efficient manner. Furthermore, the performance of applications depends on how drivers schedule/submit the work to these GPUs. The way the driver schedules the work may be crucial for the overall performance of benchmark/workload. For example, a device driver (or some other logic in a processor or GPU) may take into consideration the workload characteristics/hardware and OS (Operating System) behavior when scheduling the work to execute on a GPU.

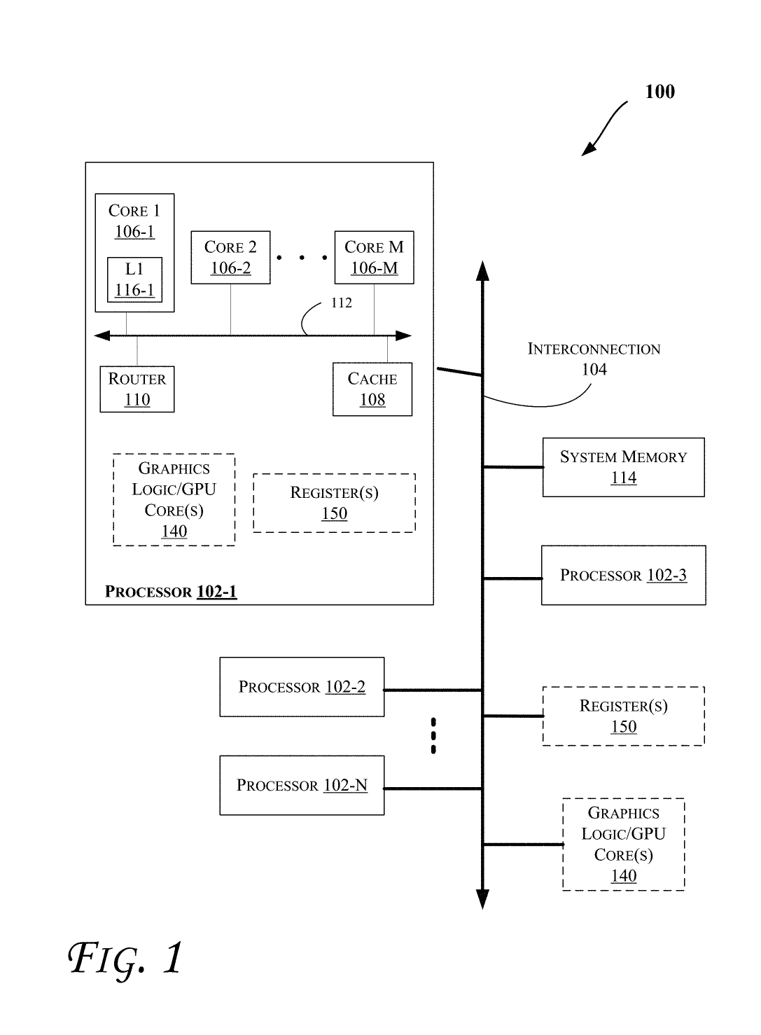

Moreover, some embodiments provide methods and apparatus for employing out-of-order queues to improve GPU utilization. One embodiment provides techniques to schedule the work based on workload characteristics (such as number of threads needed to complete the work), resources needed to complete the work (e.g., type of hardware), and/or OS behavior. This can improve the performance per Watt from the GPU. When multiple jobs are submitted to the GPU, the driver, operating in between the application and GPU hardware, packages the jobs into batches and submits the work to the GPU hardware. As discussed herein, the terms “driver” or “device driver” may interchangeably refer to logic in (or otherwise available to) a GPU or a processor (including, for example, logic 140 discussed with reference to FIGS. 1 and/or 3).

More particularly, when submitting multiple jobs, it may become very important that the driver does not introduce any bubbles in the execution pipeline of the processor/GPU. A “bubble” generally refers to a condition where the hardware is left underutilized or unutilized. In an embodiment, the driver considers various dependencies specified by application(s) across multiple jobs and schedules the work for the GPU by eliminating (or at least reducing) any unnecessary serialization events. In various embodiments, such an approach can be implemented in a GPU's OpenCL™ driver Stack and may also be adapted to other driver components. Accordingly, embodiments are not limited to OpenCL and other types of drivers (such as OpenGL®, DirectX®, etc.) may be utilized. Further, one or more embodiments provide performance benefits for real-world applications to improve performance per Watt, as well as providing a more efficient hardware utilization.

Further, some embodiments may be applied in computing systems that include one or more processors (e.g., with one or more processor cores), such as those discussed with reference to FIGS. 1-15, including for example mobile computing devices, e.g., a smartphone, tablet, UMPC (Ultra-Mobile Personal Computer), laptop computer, Ultrabook™ computing device, wearable devices (such as a smart watch or smart glasses), etc. More particularly, FIG. 1 illustrates a block diagram of a computing system 100, according to an embodiment. The system 100 may include one or more processors 102-1 through 102-N (generally referred to herein as “processors 102” or “processor 102”). The processors 102 may include general-purpose CPUs and/or GPUs in various embodiments. The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

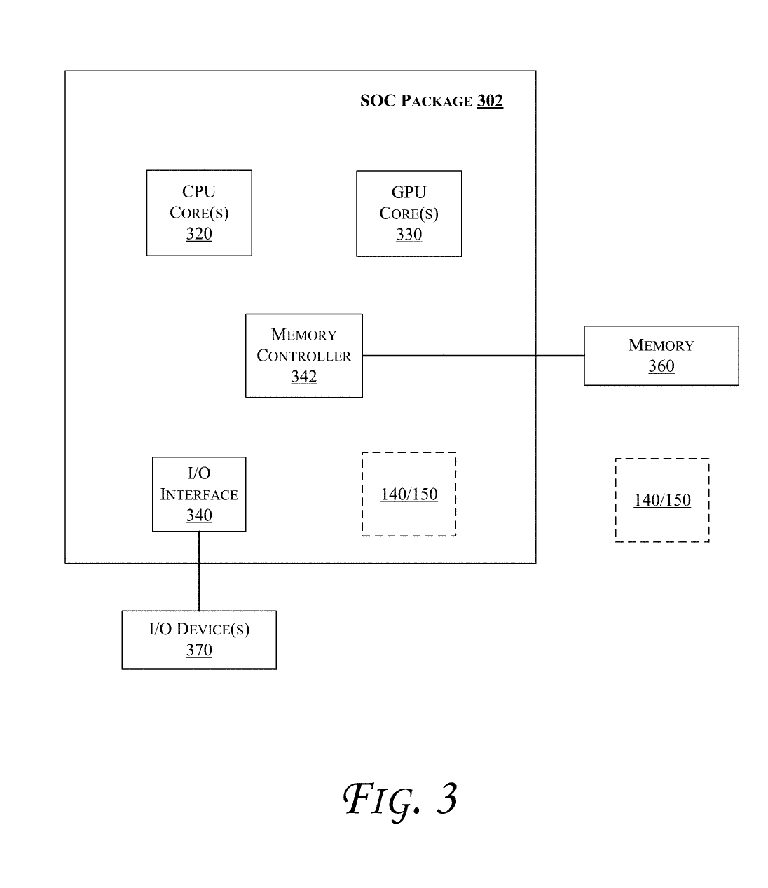

In an embodiment, the processor 102-1 may include one or more processor cores 106-1 through 106-M (referred to herein as “cores 106,” or “core 106”), a cache 108, and/or a router 110. The processor cores 106 may be implemented on a single Integrated Circuit (IC) chip. Moreover, the chip may include one or more shared and/or private caches (such as cache 108), buses or interconnections (such as a bus or interconnection 112), graphics and/or memory controllers (such as those discussed with reference to FIGS. 3-15), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. In an embodiment, the cache 108 (that may be shared) may be a mid-level cache (MLC), a last level cache (LLC), etc. Also, each of the cores 106 may include a level 1 (L1) cache (116-1) (generally referred to herein as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

As shown in FIG. 1, the processor 102 may further include graphics logic 140 (e.g., which may include one or more Graphics Processing Unit (GPU) core(s) such as those discussed with reference to FIGS. 3-15) to perform various graphics and/or general purpose computation(s) related operations such as discussed herein. Logic 140 may have access to one or more storage devices discussed herein (such as video (or image, graphics, etc.) memory, cache 108, L1 cache 116, memory 114, register(s) 150, or another memory in system 100) to store information relating to operations of the logic 140, such as information communicated with various components of system 100 as discussed herein. As discussed herein, the registers 150 may be organized into register file(s) where each register file may include an array of registers to be accessed by a CPU or GPU. Also, while logic 140 and registers 150 are shown inside the processor 102 (or coupled to interconnection 104), they may be located elsewhere in the system 100 in various embodiments. For example, logic 140 may replace one of the cores 106, may be coupled directly to interconnection 112, etc. Also, registers 150 may be directly coupled to interconnection 112, etc.

In accordance with some embodiments, sample examples of cases where one or more embodiments would be helpful include one or more of:

1. Hardware Fixed Function Operation plus General Purpose Compute—In this type of operation, generally both the jobs here (hardware fixed function operation and general purpose compute) are independent of each other. And, in some hardware architectures, there are hardware blocks/resources dedicated for fixed function operation and some dedicated for general purpose compute. So, this is an example where one embodiment helps in providing performance improvements.

2. Multiple streams of General Purpose Compute on Independent resources—Here also there is a stream of jobs received from the application which are working on totally independent resources. If the hardware has enough threads/resources and if the job streams are relatively small with the optimization techniques discussed herein (in accordance with one or more embodiments), e.g., in the driver, they can be executed faster and obtain better performance per watt.

3. Multiple Child Kernel submissions that are identified to be run independently in an OpenCL Implementation of Device Side Enqueue. The stream of child enqueue operations can be proportional to the amount of work being done by a parent kernel, and may easily explode to a large number of child kernels that are working on independent (section) of resources, in which case the Out Of Order Queues implementation (in accordance with one or more embodiments) may be very helpful.

Moreover, the above usage models fit well with the optimization techniques discussed herein (in accordance with one or more embodiments) in part because they use independent GPU resources.

In an embodiment, OpenCL applications submit work to the OpenCL Runtime using Command queues. There may be two types of Command queues which the OpenCL driver implementation can support:

a. In-Order Execution Model: A model of execution in OpenCL where the commands in a command queue are executed in order of submission with each command runs to completion before the next command begins.

b. Out-Order Execution Model: A model of execution in which commands placed in a work queue may begin and execute in any order consistent with the constraints imposed by the event wait lists and command queue barriers.

The submission to the GPU in OpenCL Driver may include two operations: (1) enqueue the work to the command queue; and/or (2) flush/submit the command queue to the hardware/GPU.

Out Of Order Execution Model support has been added in the OpenCL Driver to implement the optimization techniques discussed herein (in accordance with one or more embodiments). There are several changes done in the driver to accomplish the optimization techniques discussed herein (in accordance with one or more embodiments). The changes are described below:

1. Batching of Kernels: The driver may have previously been queueing all the commands submitted by the application in an internal queue. With this change, the driver changed the queuing model by checking if the kernel is dependent on any events that are not satisfied; if not, the driver goes ahead and processes the command making it ready for submission. In case the command depends on unresolved events at the enqueue time, it is moved to a separate storage structure for later processing. By doing this, the need for processing blocked commands and waiting for them to unblock synchronously is eliminated, allowing the non-blocked commands to be processed immediately without any unnecessary delays. The commands may be batched/combined together into one submission to optimize the number of transitions from UMD (User Mode Driver) to KMD (Kernel Mode Driver).

2. Event dependency checker: One implementation may provide an event dependency tracker for various OpenCL events e.g., by an application. A storage structure may be used to track the life-cycle of this event object by (e.g., mail-box) writes/notifications, and use these notifications to check if the dependency for a particular command has been met or not.

3. Deferred Resource Allocations: There are some resources that may be needed for executing work/commands on the GPU such as Dynamic State Heap, Surface State Heap, etc. With the out of order queue execution model (in accordance with one or more embodiments), to avoid (or at least reduce) fragmentation issues (holes in the heap blocks which are managed), a mechanism may be used to defer the heap allocation to a point where it is determined the command can be submitted to the hardware without holding on to the heap block utilized. By doing this deferred heap allocations, it is possible to eliminate (or at least reduce) fragmentation issues and/or the need to manage multiple heaps because of fragmentation issues.

4. Asynchronous Thread handling blocked commands: For adding this out of order execution model support, a mechanism may be used to support commands that are not ready for submission to GPU, e.g., because some dependency is not met. To solve this problem, a mechanism spawns a CPU thread that checks the status of the events that the command is dependent on and (e.g., only) schedules the command when it is ready (or all dependencies satisfied). This thread may be further enhanced in a power efficient way by eliminating/reducing busy-wait loops in the thread, e.g., and making it interrupt driven.

5. Device Side Enqueue Out Of Order Queue Model: Device side Enqueues (e.g., as described in OpenCL 2.0 specification) are by default Out Of Order. In this model, various resources may be used to keep track of stream of enqueues that originate from parent kernel submission. All these stream of enqueues and resources may be used for book keeping if the particular child enqueue is ready for submission is implemented in the driver. For this device side enqueue, another scheduler kernel may be implemented that is responsible for making sure that a particular child enqueue is ready to be send to hardware (or its hardware needed resources like various heaps, etc. are setup by this scheduler kernel).

By implementing (e.g., all) the above changes, it becomes possible to support an Out Of Order Execution model in the driver in accordance with one or more embodiments. And, by adding this support, excellent performance improvements for at least some classes of workloads may be achieved.

There are multiple possible solutions. Below, first we will describe each of these solutions and then discuss how our embodiment(s) are better than the possible solutions.

(a) In-Order Queue Execution Model: The use cases described above (Fixed Function hardware and General Purpose Compute, Multiple streams of General Purpose Compute) may also be supported in In-Order Execution Model. But, In-Order Queue Execution Model as required by the OpenCL Specification has to guarantee completion of the n-l^{th} command before the n^{th} command begins execution, thereby leaving the machine unutilized or underutilized.

(b) Pipe-Line Workload Execution through Resource Dependency Tracker: There may be an optimization technique done in the driver, where the driver implements a mechanism to pipeline the work submitted by the application. One optimization technique (in accordance with an embodiment) may take into consideration the resource dependencies across multiple work/command submissions in the driver and eliminate/reduce serialization events, thereby improving performance of the overall application. And, such an optimization technique discussed herein (in accordance with one or more embodiments) works great in certain classes of application and most likely improves the performance in the use cases described above. But, there are some functional limitations with this approach, e.g., where employing this technique in the driver may cause functional correctness issues with new Shared Virtual Memory feature support.

In an example, with Shared Virtual Memory, CPU and GPU can share work, e.g., where some work can be done on GPU and signal the CPU to do left over work, and vice-versa. Step 1: Enqueue Command (working on shared allocation between CPU and GPU) and this work is to complete GPU side work. Step 2: Enqueue Command (signal the CPU with mail box write to communicate that step 1 is done). Since, both the steps above are done in In Order Execution Model and by definition of In Order Execution model “Step 2” cannot execute to completion before “Step 1” and by this Pipe-Line Workload Execution optimization techniques discussed herein (in accordance with one or more embodiments) break this, and potentially Step 2 can complete before Step 1 and signaling the CPU before GPU work is actually done. Given the limitations with both the above solutions, the Out Of Order Execution Model support discussed herein (in accordance with one or more embodiments) addresses (e.g., all) the limitations and provides better performance for the application. Hence, some embodiments solve the problem with shared virtual memory implementation by separating the CPU thread to process blocked command packets, deferred heap allocations, and/or other new features.

Three use cases may be considered as examples for using out of order execution model solutions in accordance with some embodiments. First, for hardware fixed function operation and general purpose compute, for example, there may be dedicated hardware blocks/resources for fixed function operations and independent EUs (Execution Units) dedicated for General Purpose compute. The OpenCL driver has support for VME (Video Motion Estimation) fixed function through a vendor extension and it's a very commonly used feature. When executing the VME Kernel the VME fixed function hardware block is used leaving the most of General Purpose Compute hardware blocks un-utilized if this kind of usage model VME and General Purpose Compute were executed in In-Order Execution Model. But, enabling Out Of Order Execution Model makes it possible to use both the VME fixed function hardware block and General Purpose Compute hardware Blocks. The VME unit is independent from General Purpose Compute Units, but it still may use some GPGPU code run on Compute Units to feed the data to the unit and process the results for returning to user. By analyzing the VME kernel implementation and optimizing it (e.g., through data analysis below) the amount of compute units used for VME may be reduced, thereby leaving most of the compute resources for general purpose compute.

Second, Sierpiński Carpet implementation with Device Side Enqueue (Out Of Order Queue) may be used. The Sierpiński carpet is a plane fractal first described by Waclaw Sierpiński in 1916. Start with a white square. Divide the square into 9 sub-squares in a 3-by-3 grid Paint the central sub-square black. Apply the same procedure recursively to the remaining 8 sub-squares, and so on. See http://en.wikipedia.org/wiki/Sierpinski_carpet for more information on this standard benchmark, sources are available at https://software.intel.com/en-us/articles/sierpinski-carpet-in-opencl-20. Some benefits of this use case with Out Of Order Device Side Enqueue include: Speed up can be seen by about 1.66× for 243×243 on images with optimization techniques discussed herein (in accordance with one or more embodiments), e.g., varying with image sizes. For the above case, the workload may be executing thousands of dispatches that underutilize hardware without the optimization techniques discussed herein (in accordance with one or more embodiments), letting them execute concurrently with optimization techniques discussed herein (in accordance with one or more embodiments) significantly improves machine throughput which maps to performance.

Third, Multiple Streams on General Purpose Compute (e.g., Matrix Multiply) is used. Matrix multiplication is one of most commonly used General purpose compute applications. Most commercial applications generally work on stream of matrix multiplications and each set of multiplications is most likely independent set of operations which fits our out of order execution model. Matrix multiplication may significantly benefit from one or more optimization techniques discussed herein. Although matrix multiplication is specifically mentioned as an example, embodiments are not limited to matrix multiplication and use cases may be used for various types of GPGPU workloads among others.

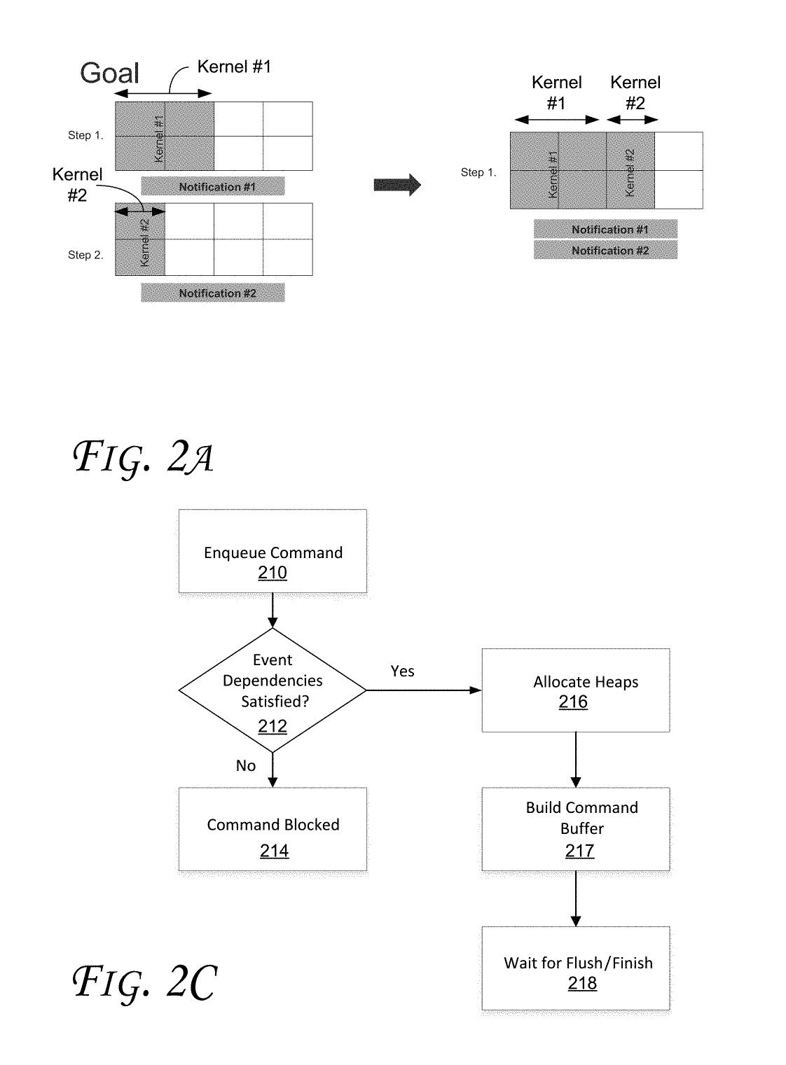

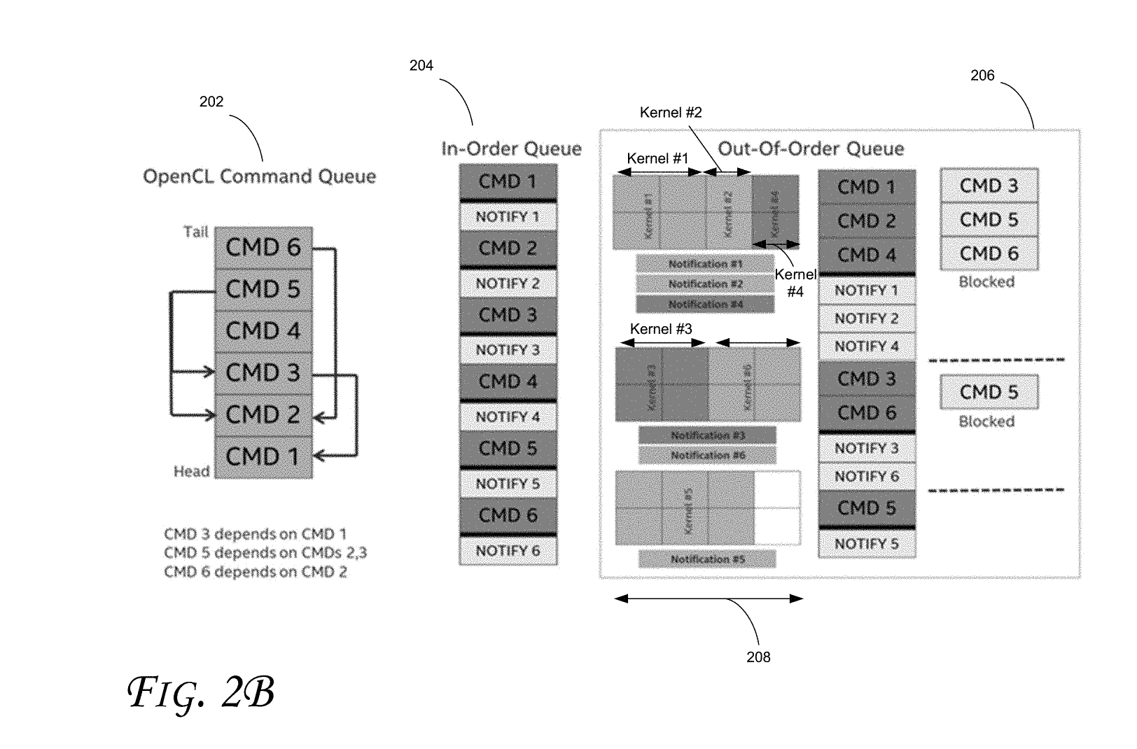

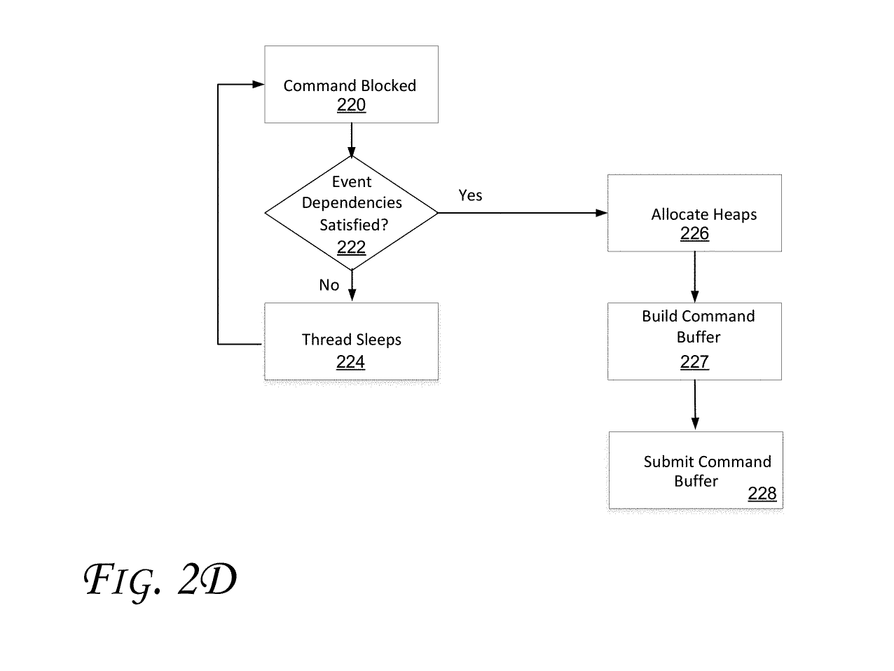

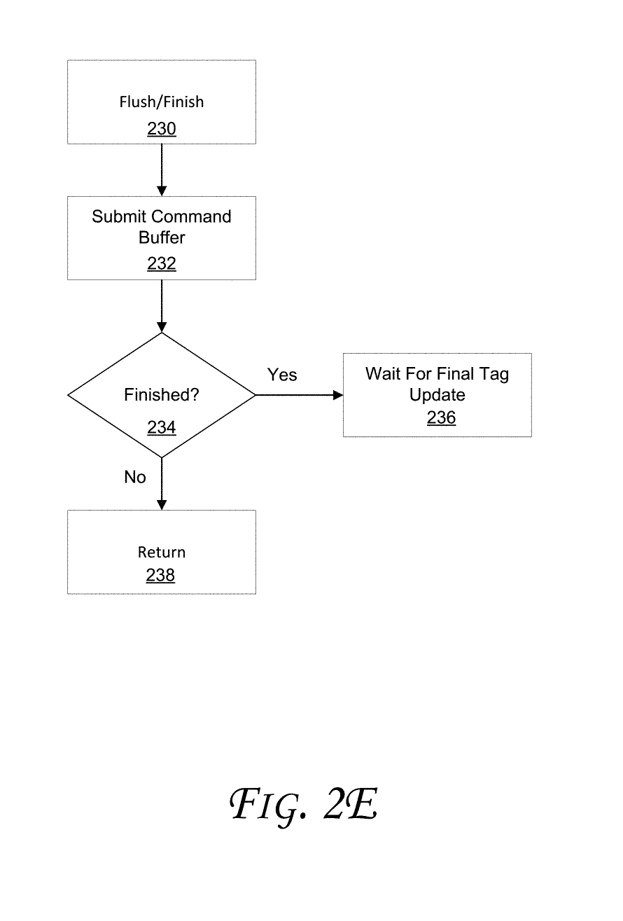

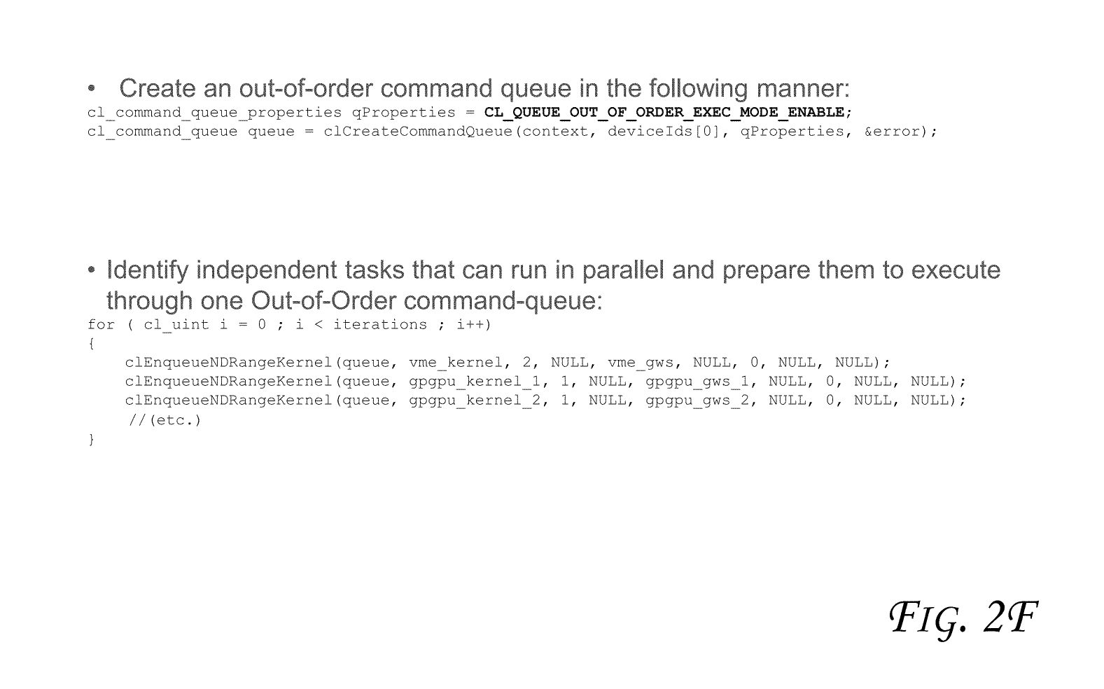

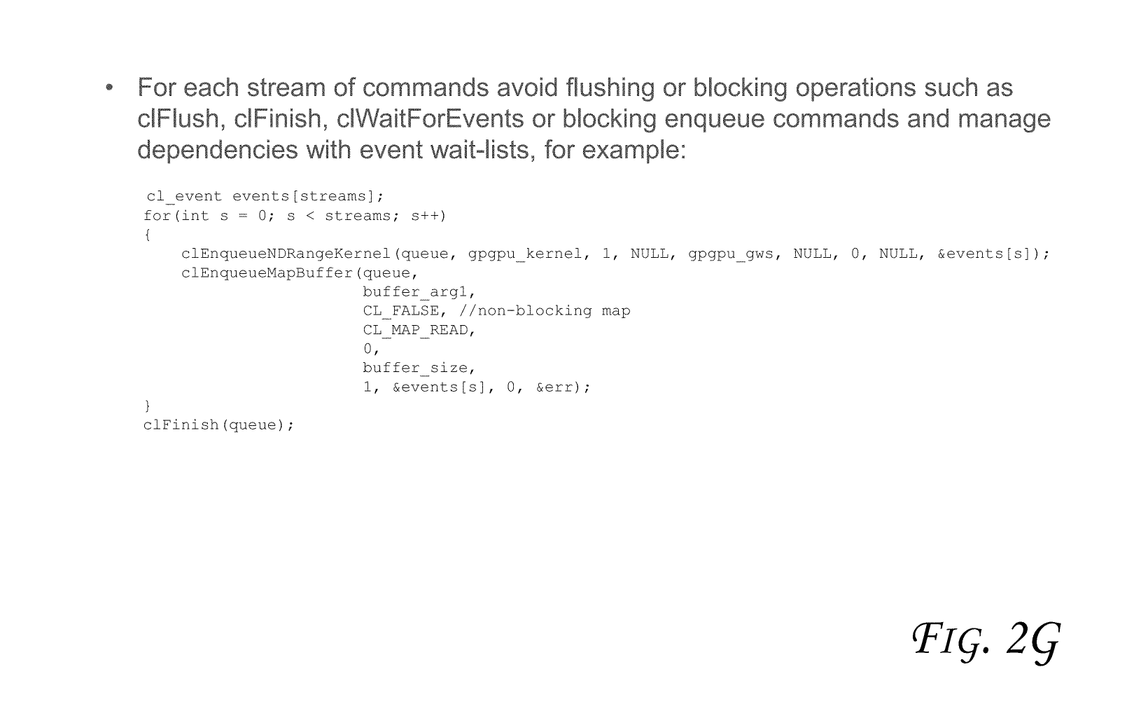

FIG. 2A shows a block diagram of work flow and organization, according to an embodiment. Let us assume we have two kernels (Kernel #1, #2) that are working on independent resources and do not have any dependency specified by application. Also, assume that these kernels are not using all the EU threads/hardware resources available in the GPU when run individually. In this example, Kernel #1 is using 50% of the GPU resources and Kernel #2 is using 25%. The diagram on the left shows each of the kernels running one after another (lock step), although not necessarily needed. Traditionally, this is how these kernels may be programmed after putting them into an in-order queue, and also programming the notifications after each command. Because of these notifications in between which are also serialization points, Kernel #2 is not going to start execution until Kernel #1 is done on the hardware, potentially under-utilizing the machine. The diagram on the right hand side of FIG. 2A shows how the two kernels could be run ideally given no dependencies between the commands, using all the EU threads/hardware resources available and keeping them busy. So, one goal is to enable independent kernels to execute simultaneously whenever possible to keep all GPU assets busy.

FIG. 2B illustrates a high level dependency diagram for out-of-order queue submission techniques, according to an embodiment. In this example, an OpenCL Command Queue 202 is shown (with its dependency graph illustrated on the left hand side of FIG. 2B). On the right hand side 204, it is illustrated how the command sequence maps to GPU/Command Buffer execution on the hardware in In-Order Execution. As can be seen, in an in-order submission (in part because it can be guaranteed that commands are retired in the same order in which they are submitted), serialization and/or notifications are provided between each command execution, which adds bubbles in the pipeline. The portion on the left hand side of box 206 shows how that would be implemented in out-of-order execution. Namely, each command that is ready for submission will have its command buffer built and those which are blocked (e.g., where event dependencies not satisfied) will be put in a blocked state.

Further, resolved commands may be sequenced in one command buffer without synchronization points in between. Instead, the synchronization point and/or the notifications may be placed at the end of the command buffer. Without the synchronization points, commands sent to GPU are allowed for pipelined/parallel execution. Completion notification and resource/Heap Management may be done through Command-id (e.g., Mail-Box write operation) with the same synchronization points at the end of the command buffer. After the process is done for commands 1, 2, and 4, the driver's blocked command packet manager thread wakes up and detects that commands 3, 6 are now ready for submission and submits them. And, this process may repeat until all the blocked command packets are processed, keeping the hardware/logic fully busy when work is submitted by elimination of serialization points. The portion 208 in the middle between the two submission models is the GPU utilization in Out-Of-Order Execution Model.

Moreover, in the example of FIG. 2B, there is a sequence of six commands sent by an application. The commands may have event dependencies specified, e.g., represented in the figure with the arrows. For instance, CMD (command) 3 depends on CMD 1, CMD5 depends on CMDs 2 and 3 and CMD 6 depends on CMD2.

If these commands were to be enqueued into an In-Order Queue, this is how they would be traditionally programmed. First—CMD 1 followed by a synchronization point and a notification that the command has completed, followed by CMD 2, a synchronization point, notification, and so on—continued for all the commands. In this model, the event dependencies do not really matter because In-Order Queue requires that all the commands begin execution and retire in the order they were enqueued, with no command starting execution before the previous command completed. Given this is not necessarily what the application intends in this case, it may not be optimal.

Let us look how we can arrange/rearrange the same set of commands if enqueued into an out-of-order queue. As you can see from the dependencies defined by the application, commands 1, 2, and 4 do not depend on any other command. At this point commands 3, 5, and 6 are in a blocked state.

Therefore, we can start from programming the command buffer for command 1, then for CMD 2 and for command 4, then we would put a synchronization point and finally place notifications marking the completion of the three commands. This way we are sending the three commands to logic for pipelined execution—and if those commands do not occupy all the hardware resources individually, they may potentially benefit from executing in parallel if possible. And in this model nothing is stopping that because in out of order queues independent commands may start execution independently.

Now given that we have already programmed the first three commands and placed a synchronization point we can now look at the remaining commands. At this point commands 3 and 6 become unblocked and we can start to program their sequences, while command 5 is still in a blocked state because it depends on command 3.

So similarly, we can program command buffers for both of the commands, followed by a synchronization point and the notifications marking completion. This time we can also expect potential benefits because we are allowing the two commands to execute simultaneously, of course depending on the GPU resources available. And going forward, we can repeat the process until all the commands are resolved and ready for execution. As can be seen, compared to the in-order queue in the optimized out of order queue model discussed herein, we are able to limit the number of synchronization points and arrange some commands for potential parallel execution.

FIG. 2C illustrates a command queuing flow chart (host side out of order queue model), according to an embodiment. FIG. 2D illustrates a flow chart for blocked command packet handling, according to an embodiment. Generally, blocked commands (those that did not satisfy the event dependencies) may be handled by a separate GPU/processor thread (e.g., that the driver maintains). That thread sleeps and wakes up (e.g., interrupt driven) to check if event dependencies are satisfied and if yes, it schedules that particular command packet. FIG. 2E illustrates a flow diagram for command submission, according to an embodiment.

In an embodiment, the driver also implements a deferred heap allocation mechanism to overcome the fragmentation issues with the heap allocation. These heaps may be used for executing commands on the GPU hardware.

For the out of order device side enqueue implementation, the device side out of order queue may have different algorithms for resource acquisition and reclamation. This process may be handled by a dedicated GPU driver called Scheduler. The scheduler may process child kernels dispatch information in the form of command packets. Each command packet may use dedicated GPU resources to be executed, including: GPU command buffer and/or GPU heaps (SSH, DSH, IOH). During each scheduler invocations, resources are treated as fully available. If the child kernel meets the following criteria, then we mark the child kernel as ready for execution in Out Of Order Queue fashion: (a) if there are no explicit event dependencies that are blocking the start of the child kernel; and (b) are the resources needed for child kernel execution, i.e. we have heap or command buffer space for this kernel.

If the above conditions are met, then we mark the child kernel ready for dispatch, this step is atomic and equivalent to resource acquisition, so if kernel is ready for submission it will be dispatched as well. After kernel is dispatched, the command packet is marked as invalid which is equivalent to command space reclamation for this child kernel. The command packet is not tracked after this step and space it used is immediately available for further blocks being scheduled on device side. Otherwise, if above conditions are not met, then child kernel dispatch data is moved to storage buffer which holds all child kernels that could not be executed yet. At the next iteration of scheduler kernel, this storage buffer can be analyzed for potential candidates for dispatching. All resources that are needed for GPU operation involving command buffer and heaps are treated as reclaimed in the next Scheduler iteration, this allows zero cost reclamation of heaps and does not require any additional bookkeeping of the resources.

Referring to FIG. 2C, at operation 210, a command is enqueued. At operation 212, it is determined whether event dependences are satisfied and if not, operation 214 blocks the command. If even dependences are satisfied, operation 216 allocates heap(s). Operation 217 builds command buffer(s) and operation 218 then waits for a flush or finish indication.

Referring to FIG. 2D, at operation 220 a command is blocked. An operation 222 determines whether event dependencies have been satisfied. If no, the thread (corresponding to the blocked command) enters sleep mode at operation 224 and the method resumes with operation 220. If event dependencies are satisfied, heap(s) are allocated at operation 226. Operation 227 builds command buffer(s), and operation 228 submits the command buffer(s).

Referring to FIG. 2E, at operation 230 a flush or finish indication is received. Operation 232 submits the command buffer to service the flush/finish. Operation 234 determines whether the flush/finish is done and if so the method waits for final tag update at operation 236. If not done, operation 238 returns.

FIG. 2F illustrates a pseudocode according to an embodiment. The sample code of FIG. 2F may be used to provide efficient use of out-of-order queues. As can be seen, the optimization is very powerful but there may be a few challenges. The out of order execution mode is not the default mode which means applications needs to explicitly turn it on. Also, existing applications may need to be slightly changed to reflect proper event dependencies in the sequence of commands. One may also need to be aware of certain limitations when it comes to GPU resources such as SLM and barriers as well as system restrictions for having multiple resources resident at the same time, etc.

FIG. 2G illustrates a pseudocode according to one embodiment. The sample code of FIG. 2G may be used to provide efficient use of the out-of-order queues. As can be seen, the optimization is very powerful but there may be a few challenges. The out of order execution mode is not the default mode which means applications need to explicitly turn it on. Also, existing applications may need to be slightly changed to reflect proper event dependencies in the sequence of commands. One may also need to be aware of certain limitations when it comes to GPU resources such as SLM and barriers as well as system restrictions for having multiple resources resident at the same time, etc.

In some embodiments, one or more of the components discussed herein can be embodied as a System On Chip (SOC) device. FIG. 3 illustrates a block diagram of an SOC package in accordance with an embodiment. As illustrated in FIG. 3, SOC 302 includes one or more Central Processing Unit (CPU) cores 320 (which may be the same as or similar to the cores 106 of FIG. 1), one or more Graphics Processor Unit (GPU) cores 330 (which may be the same as or similar to the graphics logic 140 of FIG. 1), an Input/Output (I/O) interface 340, and a memory controller 342. Various components of the SOC package 302 may be coupled to an interconnect or bus such as discussed herein with reference to the other figures. Also, the SOC package 302 may include more or less components, such as those discussed herein with reference to the other figures. Further, each component of the SOC package 320 may include one or more other components, e.g., as discussed with reference to the other figures herein. In one embodiment, SOC package 302 (and its components) is provided on one or more Integrated Circuit (IC) die, e.g., which are packaged into a single semiconductor device.

As illustrated in FIG. 3, SOC package 302 is coupled to a memory 360 (which may be similar to or the same as memory discussed herein with reference to the other figures such as system memory 114 of FIG. 1) via the memory controller 342. In an embodiment, the memory 360 (or a portion of it) can be integrated on the SOC package 302.

The I/O interface 340 may be coupled to one or more I/O devices 370, e.g., via an interconnect and/or bus such as discussed herein with reference to other figures. I/O device(s) 370 may include one or more of a keyboard, a mouse, a touchpad, a display, an image/video capture device (such as a camera or camcorder/video recorder), a touch screen, a speaker, or the like. Furthermore, SOC package 302 may include/integrate the logic 140 and/or register(s) 150 (or a portion of the register(s) 150) in an embodiment. Alternatively, the logic 140 and/or register(s) 150 (or a portion of the register(s) 150) may be provided outside of the SOC package 302 (i.e., as a discrete logic).

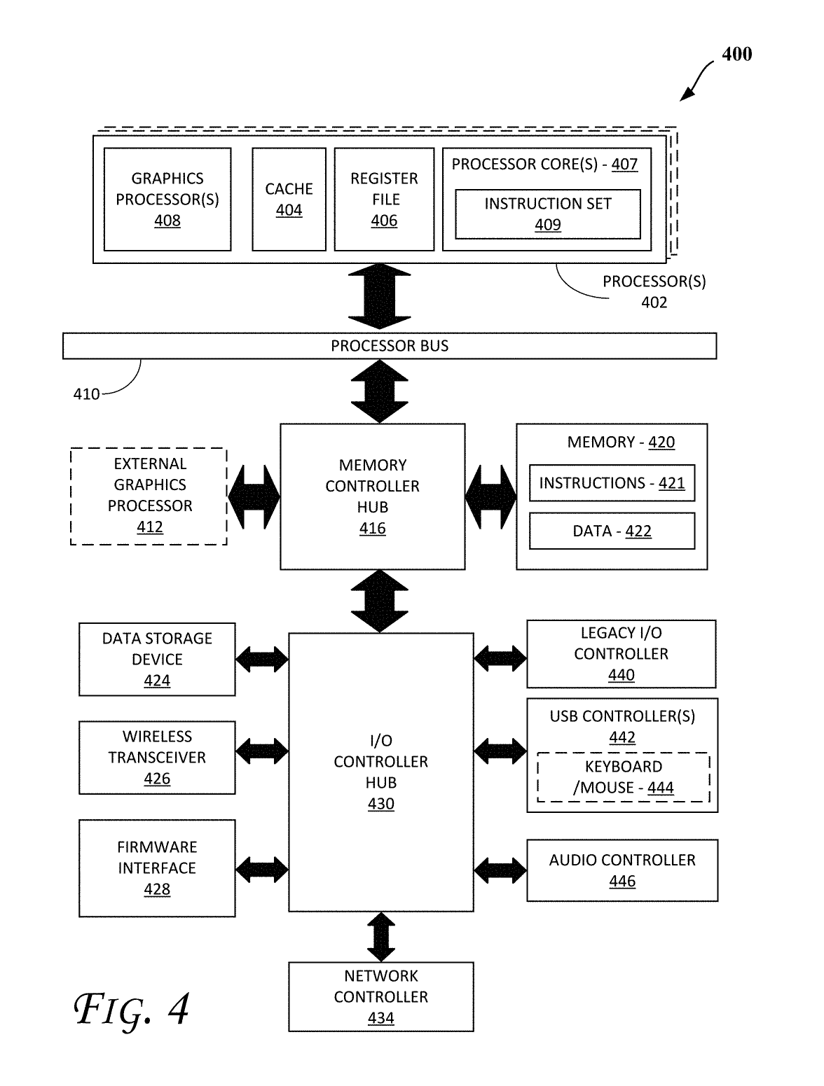

FIG. 4 is a block diagram of a processing system 400, according to an embodiment. In various embodiments the system 400 includes one or more processors 402 and one or more graphics processors 408 (such as the graphics logic 140 of FIG. 1), and may be a single processor desktop system, a multiprocessor workstation system, or a server system having a large number of processors 402 (such as processor 102 of FIG. 1) or processor cores 407 (such as cores 106 of FIG. 1). In on embodiment, the system 400 is a processing platform incorporated within a system-on-a-chip (SoC) integrated circuit for use in mobile, handheld, or embedded devices.

An embodiment of system 400 can include, or be incorporated within a server-based gaming platform, a game console, including a game and media console, a mobile gaming console, a handheld game console, or an online game console. In some embodiments system 400 is a mobile phone, smart phone, tablet computing device or mobile Internet device. Data processing system 400 can also include, couple with, or be integrated within a wearable device, such as a smart watch wearable device, smart eyewear device, augmented reality device, or virtual reality device. In some embodiments, data processing system 400 is a television or set top box device having one or more processors 402 and a graphical interface generated by one or more graphics processors 408.

In some embodiments, the one or more processors 402 each include one or more processor cores 407 to process instructions which, when executed, perform operations for system and user software. In some embodiments, each of the one or more processor cores 407 is configured to process a specific instruction set 409. In some embodiments, instruction set 409 may facilitate Complex Instruction Set Computing (CISC), Reduced Instruction Set Computing (RISC), or computing via a Very Long Instruction Word (VLIW). Multiple processor cores 407 may each process a different instruction set 409, which may include instructions to facilitate the emulation of other instruction sets. Processor core 407 may also include other processing devices, such a Digital Signal Processor (DSP).

In some embodiments, the processor 402 includes cache memory 404. Depending on the architecture, the processor 402 can have a single internal cache or multiple levels of internal cache. In some embodiments, the cache memory is shared among various components of the processor 402. In some embodiments, the processor 402 also uses an external cache (e.g., a Level-3 (L3) cache or Last Level Cache (LLC)) (not shown), which may be shared among processor cores 407 using known cache coherency techniques. A register file 406 is additionally included in processor 402 which may include different types of registers for storing different types of data (e.g., integer registers, floating point registers, status registers, and an instruction pointer register). Some registers may be general-purpose registers, while other registers may be specific to the design of the processor 402.

In some embodiments, processor 402 is coupled to a processor bus 410 to transmit communication signals such as address, data, or control signals between processor 402 and other components in system 400. In one embodiment the system 400 uses an exemplary ‘hub’ system architecture, including a memory controller hub 416 and an Input Output (I/O) controller hub 430. A memory controller hub 416 facilitates communication between a memory device and other components of system 400, while an I/O Controller Hub (ICH) 430 provides connections to I/O devices via a local I/O bus. In one embodiment, the logic of the memory controller hub 416 is integrated within the processor.

Memory device 420 can be a dynamic random access memory (DRAM) device, a static random access memory (SRAM) device, flash memory device, phase-change memory device, or some other memory device having suitable performance to serve as process memory. In one embodiment the memory device 420 can operate as system memory for the system 400, to store data 422 and instructions 421 for use when the one or more processors 402 executes an application or process. Memory controller hub 416 also couples with an optional external graphics processor 412, which may communicate with the one or more graphics processors 408 in processors 402 to perform graphics and media operations.

In some embodiments, ICH 430 enables peripherals to connect to memory device 420 and processor 402 via a high-speed I/O bus. The I/O peripherals include, but are not limited to, an audio controller 446, a firmware interface 428, a wireless transceiver 426 (e.g., Wi-Fi, Bluetooth), a data storage device 424 (e.g., hard disk drive, flash memory, etc.), and a legacy I/O controller 440 for coupling legacy (e.g., Personal System 2 (PS/2)) devices to the system. One or more Universal Serial Bus (USB) controllers 442 connect input devices, such as keyboard and mouse 444 combinations. A network controller 434 may also couple to ICH 430. In some embodiments, a high-performance network controller (not shown) couples to processor bus 410. It will be appreciated that the system 400 shown is exemplary and not limiting, as other types of data processing systems that are differently configured may also be used. For example, the I/O controller hub 430 may be integrated within the one or more processor 402, or the memory controller hub 416 and I/O controller hub 430 may be integrated into a discreet external graphics processor, such as the external graphics processor 412.

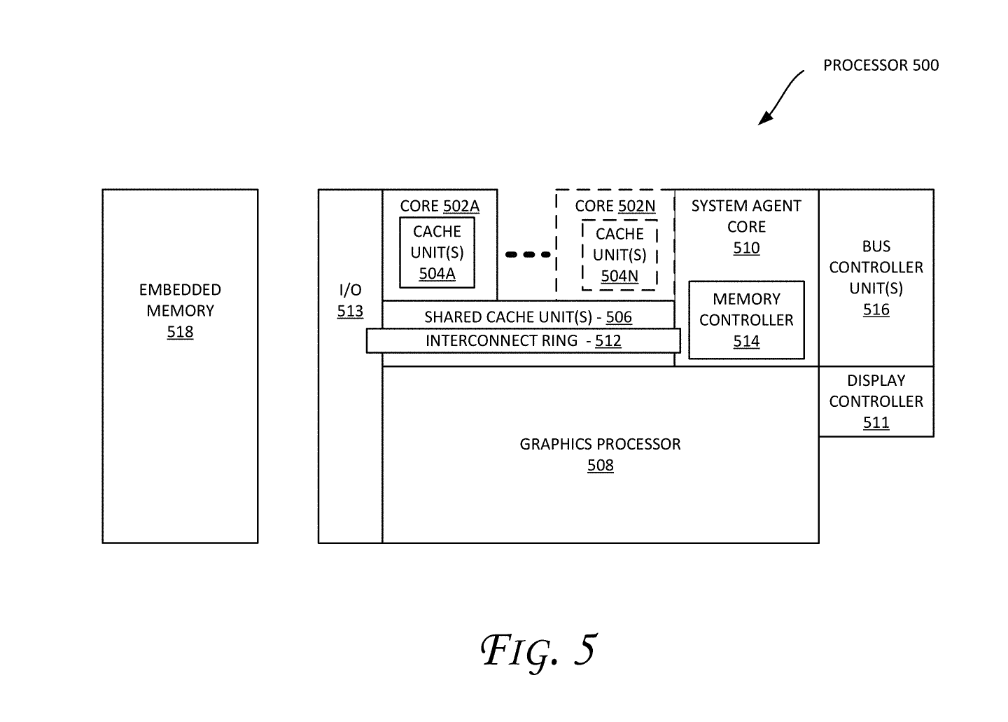

FIG. 5 is a block diagram of an embodiment of a processor 500 having one or more processor cores 502A-502N, an integrated memory controller 514, and an integrated graphics processor 508. The processor 500 may be similar to or the same as the processor 102 discussed with reference to FIG. 1. Those elements of FIG. 5 having the same reference numbers (or names) as the elements of any other figure herein can operate or function in any manner similar to that described elsewhere herein, but are not limited to such. Processor 500 can include additional cores up to and including additional core 502N represented by the dashed lined boxes. Each of processor cores 502A-502N includes one or more internal cache units 504A-504N. In some embodiments each processor core also has access to one or more shared cached units 506.

The internal cache units 504A-504N and shared cache units 506 represent a cache memory hierarchy within the processor 500. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 506 and 504A-504N.

In some embodiments, processor 500 may also include a set of one or more bus controller units 516 and a system agent core 510. The one or more bus controller units 516 manage a set of peripheral buses, such as one or more Peripheral Component Interconnect buses (e.g., PCI, PCI Express). System agent core 510 provides management functionality for the various processor components. In some embodiments, system agent core 510 includes one or more integrated memory controllers 514 to manage access to various external memory devices (not shown).

In some embodiments, one or more of the processor cores 502A-502N include support for simultaneous multi-threading. In such embodiment, the system agent core 510 includes components for coordinating and operating cores 502A-502N during multi-threaded processing. System agent core 510 may additionally include a power control unit (PCU), which includes logic and components to regulate the power state of processor cores 502A-502N and graphics processor 508.

In some embodiments, processor 500 additionally includes graphics processor 508 to execute graphics processing operations. In some embodiments, the graphics processor 508 couples with the set of shared cache units 506, and the system agent core 510, including the one or more integrated memory controllers 514. In some embodiments, a display controller 511 is coupled with the graphics processor 508 to drive graphics processor output to one or more coupled displays. In some embodiments, display controller 511 may be a separate module coupled with the graphics processor via at least one interconnect, or may be integrated within the graphics processor 508 or system agent core 510.

In some embodiments, a ring based interconnect unit 512 is used to couple the internal components of the processor 500. However, an alternative interconnect unit may be used, such as a point-to-point interconnect, a switched interconnect, or other techniques, including techniques well known in the art. In some embodiments, graphics processor 508 couples with the ring interconnect 512 via an I/O link 513.

The exemplary I/O link 513 represents at least one of multiple varieties of I/O interconnects, including an on package I/O interconnect which facilitates communication between various processor components and a high-performance embedded memory module 518, such as an eDRAM (or embedded DRAM) module. In some embodiments, each of the processor cores 502-502N and graphics processor 508 use embedded memory modules 518 as a shared Last Level Cache.

In some embodiments, processor cores 502A-502N are homogenous cores executing the same instruction set architecture. In another embodiment, processor cores 502A-502N are heterogeneous in terms of instruction set architecture (ISA), where one or more of processor cores 502A-502N execute a first instruction set, while at least one of the other cores executes a subset of the first instruction set or a different instruction set. In one embodiment processor cores 502A-502N are heterogeneous in terms of microarchitecture, where one or more cores having a relatively higher power consumption couple with one or more power cores having a lower power consumption. Additionally, processor 500 can be implemented on one or more chips or as an SoC integrated circuit having the illustrated components, in addition to other components.

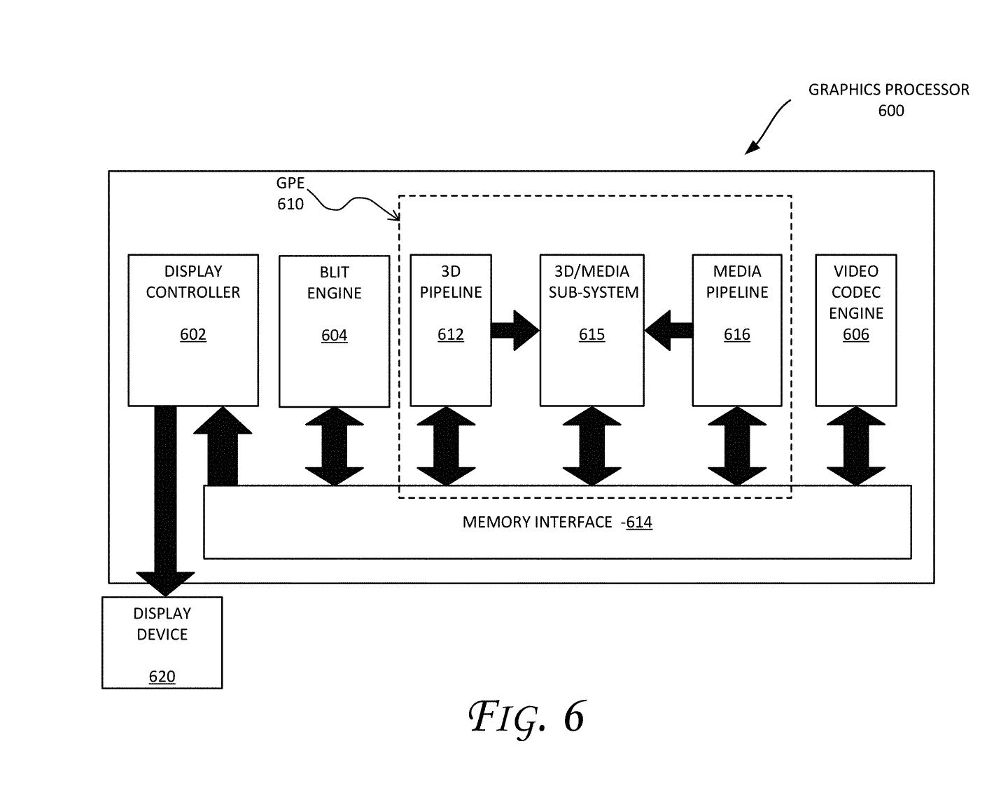

FIG. 6 is a block diagram of a graphics processor 600, which may be a discrete graphics processing unit, or may be a graphics processor integrated with a plurality of processing cores. The graphics processor 600 may be similar to or the same as the graphics logic 140 discussed with reference to FIG. 1. In some embodiments, the graphics processor communicates via a memory mapped I/O interface to registers on the graphics processor and with commands placed into the processor memory. In some embodiments, graphics processor 600 includes a memory interface 614 to access memory. Memory interface 614 can be an interface to local memory, one or more internal caches, one or more shared external caches, and/or to system memory.

In some embodiments, graphics processor 600 also includes a display controller 602 to drive display output data to a display device 620. Display controller 602 includes hardware for one or more overlay planes for the display and composition of multiple layers of video or user interface elements. In some embodiments, graphics processor 600 includes a video codec engine 606 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 421M/VC-1, and Joint Photographic Experts Group (JPEG) formats such as JPEG, and Motion JPEG (MJPEG) formats.

In some embodiments, graphics processor 600 includes a block image transfer (BLIT) engine 604 to perform two-dimensional (2D) rasterizer operations including, for example, bit-boundary block transfers. However, in one embodiment, 2D graphics operations are performed using one or more components of graphics processing engine (GPE) 610. In some embodiments, graphics processing engine 610 is a compute engine for performing graphics operations, including three-dimensional (3D) graphics operations and media operations.

In some embodiments, GPE 610 includes a 3D pipeline 612 for performing 3D operations, such as rendering three-dimensional images and scenes using processing functions that act upon 3D primitive shapes (e.g., rectangle, triangle, etc.). The 3D pipeline 612 includes programmable and fixed function elements that perform various tasks within the element and/or spawn execution threads to a 3D/Media sub-system 615. While 3D pipeline 612 can be used to perform media operations, an embodiment of GPE 610 also includes a media pipeline 616 that is specifically used to perform media operations, such as video post-processing and image enhancement.

In some embodiments, media pipeline 616 includes fixed function or programmable logic units to perform one or more specialized media operations, such as video decode acceleration, video de-interlacing, and video encode acceleration in place of, or on behalf of video codec engine 606. In some embodiments, media pipeline 616 additionally includes a thread spawning unit to spawn threads for execution on 3D/Media sub-system 615. The spawned threads perform computations for the media operations on one or more graphics execution units included in 3D/Media sub-system 615.

In some embodiments, 3D/Media subsystem 615 includes logic for executing threads spawned by 3D pipeline 612 and media pipeline 616. In one embodiment, the pipelines send thread execution requests to 3D/Media subsystem 615, which includes thread dispatch logic for arbitrating and dispatching the various requests to available thread execution resources. The execution resources include an array of graphics execution units to process the 3D and media threads. In some embodiments, 3D/Media subsystem 615 includes one or more internal caches for thread instructions and data. In some embodiments, the subsystem also includes shared memory, including registers and addressable memory, to share data between threads and to store output data.

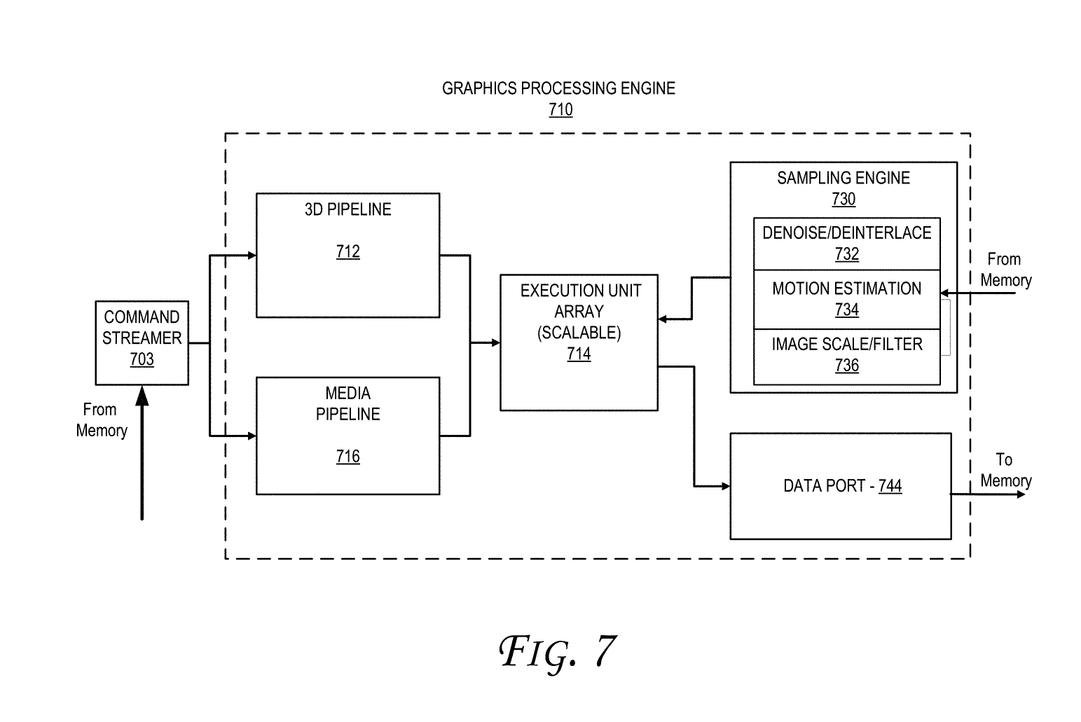

FIG. 7 is a block diagram of a graphics processing engine 710 of a graphics processor in accordance with some embodiments. In one embodiment, the GPE 710 is a version of the GPE 610 shown in FIG. 6. Elements of FIG. 7 having the same reference numbers (or names) as the elements of any other figure herein can operate or function in any manner similar to that described elsewhere herein, but are not limited to such.

In some embodiments, GPE 710 couples with a command streamer 703, which provides a command stream to the GPE 3D and media pipelines 712, 716. In some embodiments, command streamer 703 is coupled to memory, which can be system memory, or one or more of internal cache memory and shared cache memory. In some embodiments, command streamer 703 receives commands from the memory and sends the commands to 3D pipeline 712 and/or media pipeline 716. The commands are directives fetched from a ring buffer, which stores commands for the 3D and media pipelines 712, 716. In one embodiment, the ring buffer can additionally include batch command buffers storing batches of multiple commands. The 3D and media pipelines 712, 716 process the commands by performing operations via logic within the respective pipelines or by dispatching one or more execution threads to an execution unit array 714. In some embodiments, execution unit array 714 is scalable, such that the array includes a variable number of execution units based on the target power and performance level of GPE 710.

In some embodiments, a sampling engine 730 couples with memory (e.g., cache memory or system memory) and execution unit array 714. In some embodiments, sampling engine 730 provides a memory access mechanism for execution unit array 714 that allows execution array 714 to read graphics and media data from memory. In some embodiments, sampling engine 730 includes logic to perform specialized image sampling operations for media.

In some embodiments, the specialized media sampling logic in sampling engine 730 includes a de-noise/de-interlace module 732, a motion estimation module 734, and an image scaling and filtering module 736. In some embodiments, de-noise/de-interlace module 732 includes logic to perform one or more of a de-noise or a de-interlace algorithm on decoded video data. The de-interlace logic combines alternating fields of interlaced video content into a single fame of video. The de-noise logic reduces or removes data noise from video and image data. In some embodiments, the de-noise logic and de-interlace logic are motion adaptive and use spatial or temporal filtering based on the amount of motion detected in the video data. In some embodiments, the de-noise/de-interlace module 732 includes dedicated motion detection logic (e.g., within the motion estimation engine 734).

In some embodiments, motion estimation engine 734 provides hardware acceleration for video operations by performing video acceleration functions such as motion vector estimation and prediction on video data. The motion estimation engine determines motion vectors that describe the transformation of image data between successive video frames. In some embodiments, a graphics processor media codec uses video motion estimation engine 734 to perform operations on video at the macro-block level that may otherwise be too computationally intensive to perform with a general-purpose processor. In some embodiments, motion estimation engine 734 is generally available to graphics processor components to assist with video decode and processing functions that are sensitive or adaptive to the direction or magnitude of the motion within video data.

In some embodiments, image scaling and filtering module 736 performs image-processing operations to enhance the visual quality of generated images and video. In some embodiments, scaling and filtering module 736 processes image and video data during the sampling operation before providing the data to execution unit array 714.

In some embodiments, the GPE 710 includes a data port 744, which provides an additional mechanism for graphics subsystems to access memory. In some embodiments, data port 744 facilitates memory access for operations including render target writes, constant buffer reads, scratch memory space reads/writes, and media surface accesses. In some embodiments, data port 744 includes cache memory space to cache accesses to memory. The cache memory can be a single data cache or separated into multiple caches for the multiple subsystems that access memory via the data port (e.g., a render buffer cache, a constant buffer cache, etc.). In some embodiments, threads executing on an execution unit in execution unit array 714 communicate with the data port by exchanging messages via a data distribution interconnect that couples each of the sub-systems of GPE 710.

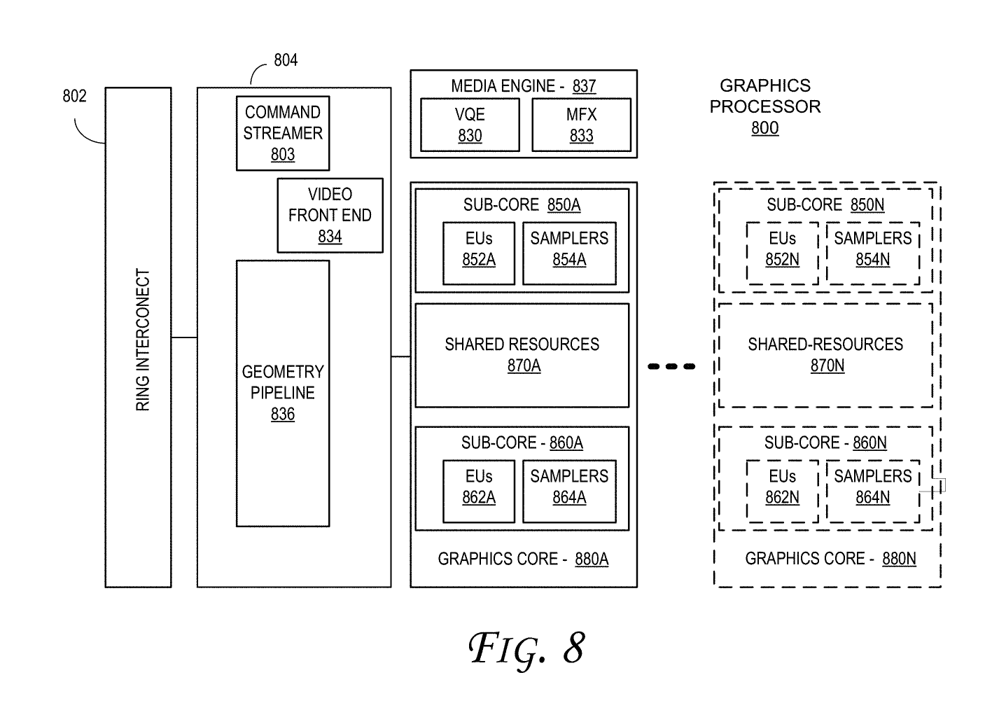

FIG. 8 is a block diagram of another embodiment of a graphics processor 800. Elements of FIG. 8 having the same reference numbers (or names) as the elements of any other figure herein can operate or function in any manner similar to that described elsewhere herein, but are not limited to such.

In some embodiments, graphics processor 800 includes a ring interconnect 802, a pipeline front-end 804, a media engine 837, and graphics cores 880A-880N. In some embodiments, ring interconnect 802 couples the graphics processor to other processing units, including other graphics processors or one or more general-purpose processor cores. In some embodiments, the graphics processor is one of many processors integrated within a multi-core processing system.

In some embodiments, graphics processor 800 receives batches of commands via ring interconnect 802. The incoming commands are interpreted by a command streamer 803 in the pipeline front-end 804. In some embodiments, graphics processor 800 includes scalable execution logic to perform 3D geometry processing and media processing via the graphics core(s) 880A-880N. For 3D geometry processing commands, command streamer 803 supplies commands to geometry pipeline 836. For at least some media processing commands, command streamer 803 supplies the commands to a video front end 834, which couples with a media engine 837. In some embodiments, media engine 837 includes a Video Quality Engine (VQE) 830 for video and image post-processing and a multi-format encode/decode (MFX) 833 engine to provide hardware-accelerated media data encode and decode. In some embodiments, geometry pipeline 836 and media engine 837 each generate execution threads for the thread execution resources provided by at least one graphics core 880A.

In some embodiments, graphics processor 800 includes scalable thread execution resources featuring modular cores 880A-880N (sometimes referred to as core slices), each having multiple sub-cores 850A-850N, 860A-860N (sometimes referred to as core sub-slices). In some embodiments, graphics processor 800 can have any number of graphics cores 880A through 880N. In some embodiments, graphics processor 800 includes a graphics core 880A having at least a first sub-core 850A and a second core sub-core 860A. In other embodiments, the graphics processor is a low power processor with a single sub-core (e.g., 850A). In some embodiments, graphics processor 800 includes multiple graphics cores 880A-880N, each including a set of first sub-cores 850A-850N and a set of second sub-cores 860A-860N. Each sub-core in the set of first sub-cores 850A-850N includes at least a first set of execution units 852A-852N and media/texture samplers 854A-854N. Each sub-core in the set of second sub-cores 860A-860N includes at least a second set of execution units 862A-862N and samplers 864A-864N. In some embodiments, each sub-core 850A-850N, 860A-860N shares a set of shared resources 870A-870N. In some embodiments, the shared resources include shared cache memory and pixel operation logic. Other shared resources may also be included in the various embodiments of the graphics processor.

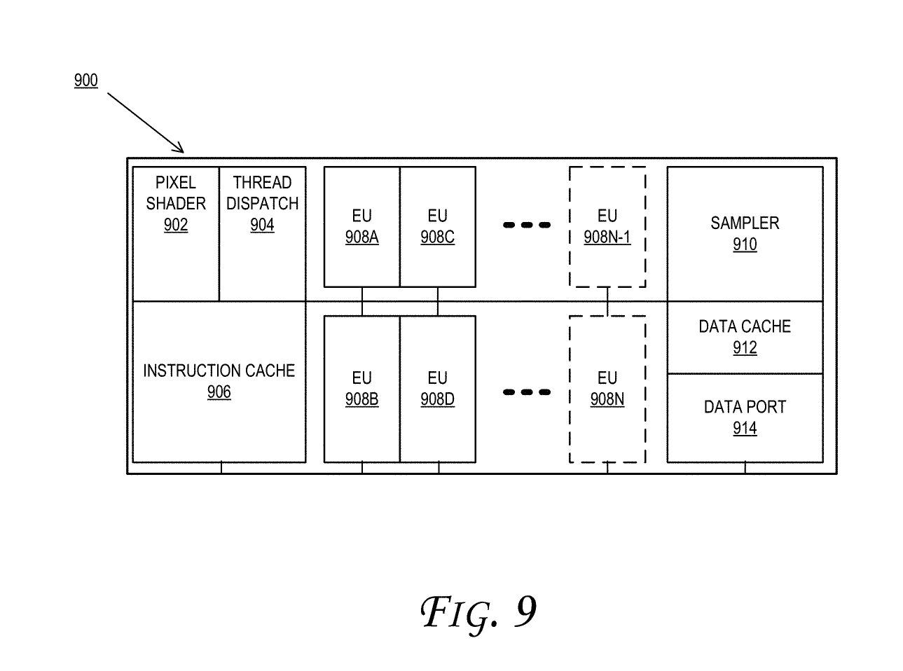

FIG. 9 illustrates thread execution logic 900 including an array of processing elements employed in some embodiments of a GPE. Elements of FIG. 9 having the same reference numbers (or names) as the elements of any other figure herein can operate or function in any manner similar to that described elsewhere herein, but are not limited to such.

In some embodiments, thread execution logic 900 includes a pixel shader 902, a thread dispatcher 904, instruction cache 906, a scalable execution unit array including a plurality of execution units 908A-908N, a sampler 910, a data cache 912, and a data port 914. In one embodiment the included components are interconnected via an interconnect fabric that links to each of the components. In some embodiments, thread execution logic 900 includes one or more connections to memory, such as system memory or cache memory, through one or more of instruction cache 906, data port 914, sampler 910, and execution unit array 908A-908N. In some embodiments, each execution unit (e.g., 908A) is an individual vector processor capable of executing multiple simultaneous threads and processing multiple data elements in parallel for each thread. In some embodiments, execution unit array 908A-908N includes any number individual execution units.

In some embodiments, execution unit array 908A-908N is primarily used to execute “shader” programs. In some embodiments, the execution units in array 908A-908N execute an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders).

Each execution unit in execution unit array 908A-908N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some embodiments, execution units 908A-908N support integer and floating-point data types.

The execution unit instruction set includes single instruction multiple data (SIMD) instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

One or more internal instruction caches (e.g., 906) are included in the thread execution logic 900 to cache thread instructions for the execution units. In some embodiments, one or more data caches (e.g., 912) are included to cache thread data during thread execution. In some embodiments, sampler 910 is included to provide texture sampling for 3D operations and media sampling for media operations. In some embodiments, sampler 910 includes specialized texture or media sampling functionality to process texture or media data during the sampling process before providing the sampled data to an execution unit.

During execution, the graphics and media pipelines send thread initiation requests to thread execution logic 900 via thread spawning and dispatch logic. In some embodiments, thread execution logic 900 includes a local thread dispatcher 904 that arbitrates thread initiation requests from the graphics and media pipelines and instantiates the requested threads on one or more execution units 908A-908N. For example, the geometry pipeline (e.g., 836 of FIG. 8) dispatches vertex processing, tessellation, or geometry processing threads to thread execution logic 900 (FIG. 9). In some embodiments, thread dispatcher 904 can also process runtime thread spawning requests from the executing shader programs.

Once a group of geometric objects has been processed and rasterized into pixel data, pixel shader 902 is invoked to further compute output information and cause results to be written to output surfaces (e.g., color buffers, depth buffers, stencil buffers, etc.). In some embodiments, pixel shader 902 calculates the values of the various vertex attributes that are to be interpolated across the rasterized object. In some embodiments, pixel shader 902 then executes an application programming interface (API)-supplied pixel shader program. To execute the pixel shader program, pixel shader 902 dispatches threads to an execution unit (e.g., 908A) via thread dispatcher 904. In some embodiments, pixel shader 902 uses texture sampling logic in sampler 910 to access texture data in texture maps stored in memory. Arithmetic operations on the texture data and the input geometry data compute pixel color data for each geometric fragment, or discards one or more pixels from further processing.

In some embodiments, the data port 914 provides a memory access mechanism for the thread execution logic 900 output processed data to memory for processing on a graphics processor output pipeline. In some embodiments, the data port 914 includes or couples to one or more cache memories (e.g., data cache 912) to cache data for memory access via the data port.

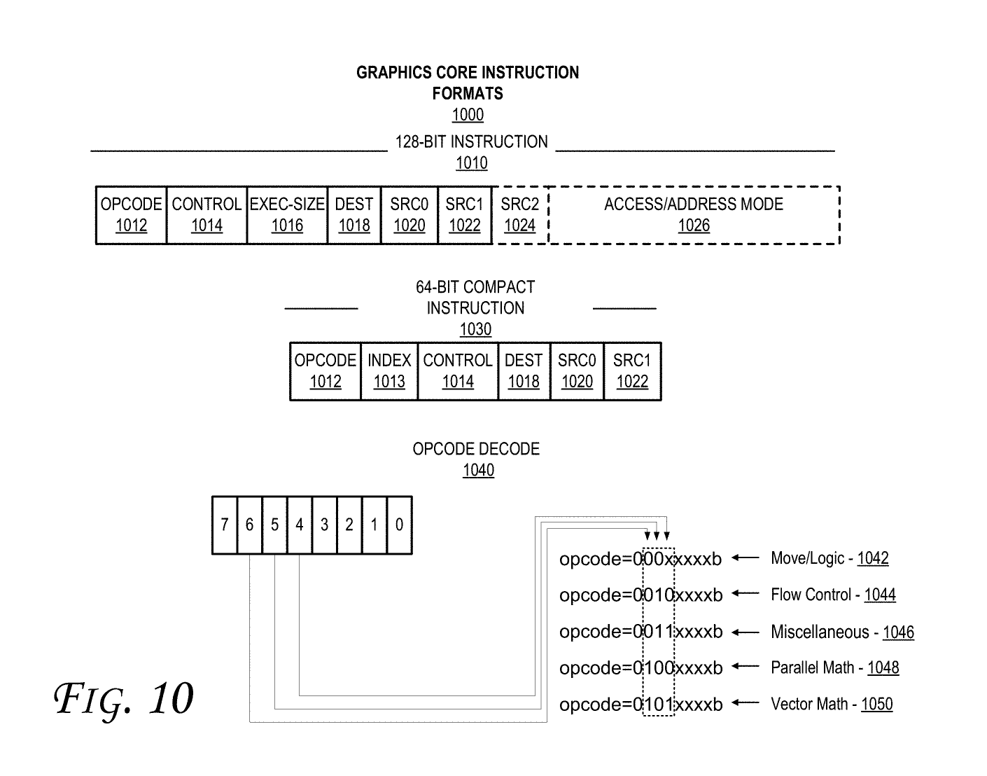

FIG. 10 is a block diagram illustrating a graphics processor instruction formats 1000 according to some embodiments. In one or more embodiment, the graphics processor execution units support an instruction set having instructions in multiple formats. The solid lined boxes illustrate the components that are generally included in an execution unit instruction, while the dashed lines include components that are optional or that are only included in a sub-set of the instructions. In some embodiments, instruction format 1000 described and illustrated are macro-instructions, in that they are instructions supplied to the execution unit, as opposed to micro-operations resulting from instruction decode once the instruction is processed.

In some embodiments, the graphics processor execution units natively support instructions in a 128-bit format 1010. A 64-bit compacted instruction format 1030 is available for some instructions based on the selected instruction, instruction options, and number of operands. The native 128-bit format 1010 provides access to all instruction options, while some options and operations are restricted in the 64-bit format 1030. The native instructions available in the 64-bit format 1030 vary by embodiment. In some embodiments, the instruction is compacted in part using a set of index values in an index field 1013. The execution unit hardware references a set of compaction tables based on the index values and uses the compaction table outputs to reconstruct a native instruction in the 128-bit format 1010.

For each format, instruction opcode 1012 defines the operation that the execution unit is to perform. The execution units execute each instruction in parallel across the multiple data elements of each operand. For example, in response to an add instruction the execution unit performs a simultaneous add operation across each color channel representing a texture element or picture element. By default, the execution unit performs each instruction across all data channels of the operands. In some embodiments, instruction control field 1014 enables control over certain execution options, such as channels selection (e.g., predication) and data channel order (e.g., swizzle). For 128-bit instructions 1010 an exec-size field 1016 limits the number of data channels that will be executed in parallel. In some embodiments, exec-size field 1016 is not available for use in the 64-bit compact instruction format 1030.

Some execution unit instructions have up to three operands including two source operands, src0 1022, src1 1022, and one destination 1018. In some embodiments, the execution units support dual destination instructions, where one of the destinations is implied. Data manipulation instructions can have a third source operand (e.g., SRC2 1024), where the instruction opcode 1012 determines the number of source operands. An instruction's last source operand can be an immediate (e.g., hard-coded) value passed with the instruction.

In some embodiments, the 128-bit instruction format 1010 includes an access/address mode information 1026 specifying, for example, whether direct register addressing mode or indirect register addressing mode is used. When direct register addressing mode is used, the register address of one or more operands is directly provided by bits in the instruction 1010.

In some embodiments, the 128-bit instruction format 1010 includes an access/address mode field 1026, which specifies an address mode and/or an access mode for the instruction. In one embodiment the access mode to define a data access alignment for the instruction. Some embodiments support access modes including a 16-byte aligned access mode and a 1-byte aligned access mode, where the byte alignment of the access mode determines the access alignment of the instruction operands. For example, when in a first mode, the instruction 1010 may use byte-aligned addressing for source and destination operands and when in a second mode, the instruction 1010 may use 16-byte-aligned addressing for all source and destination operands.

In one embodiment, the address mode portion of the access/address mode field 1026 determines whether the instruction is to use direct or indirect addressing. When direct register addressing mode is used bits in the instruction 1010 directly provide the register address of one or more operands. When indirect register addressing mode is used, the register address of one or more operands may be computed based on an address register value and an address immediate field in the instruction.

In some embodiments instructions are grouped based on opcode 1012 bit-fields to simplify Opcode decode 1040. For an 8-bit opcode, bits 10, 11, and 12 allow the execution unit to determine the type of opcode. The precise opcode grouping shown is merely an example. In some embodiments, a move and logic opcode group 1042 includes data movement and logic instructions (e.g., move (mov), compare (cmp)). In some embodiments, move and logic group 1042 shares the five most significant bits (MSB), where move (mov) instructions are in the form of 0000xxxxb and logic instructions are in the form of 0001xxxxb. A flow control instruction group 1044 (e.g., call, jump (jmp)) includes instructions in the form of 0010xxxxb (e.g., 0x20). A miscellaneous instruction group 1046 includes a mix of instructions, including synchronization instructions (e.g., wait, send) in the form of 0011xxxxb (e.g., 0x30). A parallel math instruction group 1048 includes component-wise arithmetic instructions (e.g., add, multiply (mul)) in the form of 0100xxxxb (e.g., 0x40). The parallel math group 1048 performs the arithmetic operations in parallel across data channels. The vector math group 1050 includes arithmetic instructions (e.g., dp 4) in the form of 0101xxxxb (e.g., 0x50). The vector math group performs arithmetic such as dot product calculations on vector operands.

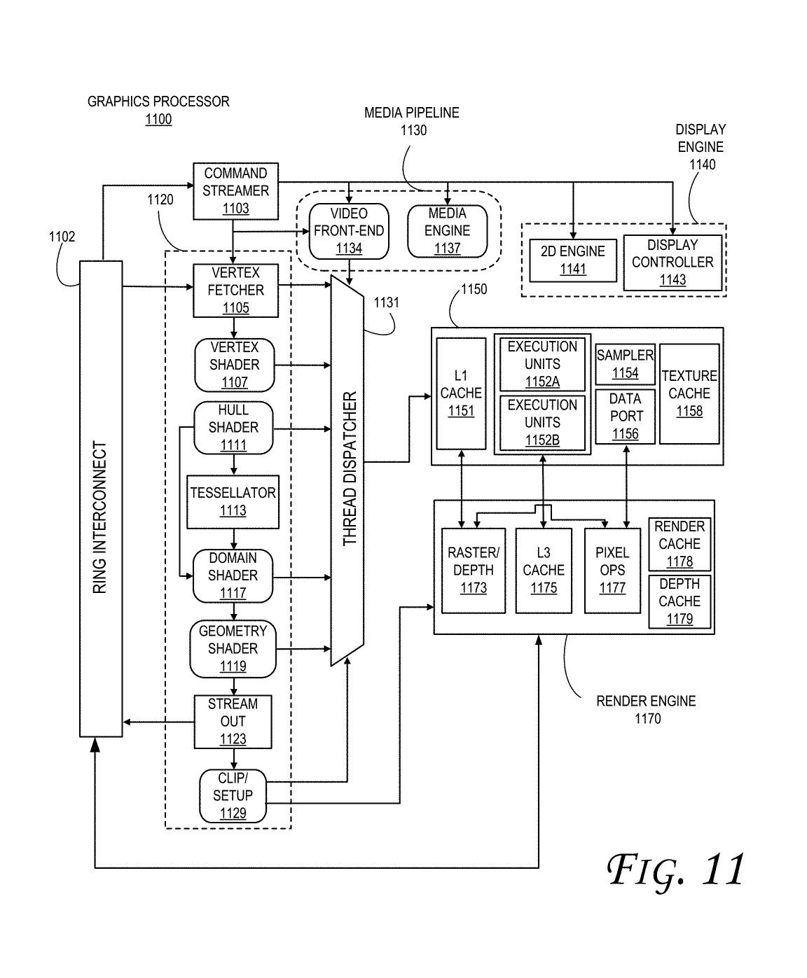

FIG. 11 is a block diagram of another embodiment of a graphics processor 1100. Elements of FIG. 11 having the same reference numbers (or names) as the elements of any other figure herein can operate or function in any manner similar to that described elsewhere herein, but are not limited to such.

In some embodiments, graphics processor 1100 includes a graphics pipeline 1120, a media pipeline 1130, a display engine 1140, thread execution logic 1150, and a render output pipeline 1170. In some embodiments, graphics processor 1100 is a graphics processor within a multi-core processing system that includes one or more general purpose processing cores. The graphics processor is controlled by register writes to one or more control registers (not shown) or via commands issued to graphics processor 1100 via a ring interconnect 1102. In some embodiments, ring interconnect 1102 couples graphics processor 1100 to other processing components, such as other graphics processors or general-purpose processors. Commands from ring interconnect 1102 are interpreted by a command streamer 1103, which supplies instructions to individual components of graphics pipeline 1120 or media pipeline 1130.

In some embodiments, command streamer 1103 directs the operation of a vertex fetcher 1105 that reads vertex data from memory and executes vertex-processing commands provided by command streamer 1103. In some embodiments, vertex fetcher 1105 provides vertex data to a vertex shader 1107, which performs coordinate space transformation and lighting operations to each vertex. In some embodiments, vertex fetcher 1105 and vertex shader 1107 execute vertex-processing instructions by dispatching execution threads to execution units 1152A, 1152B via a thread dispatcher 1131.

In some embodiments, execution units 1152A, 1152B are an array of vector processors having an instruction set for performing graphics and media operations. In some embodiments, execution units 1152A, 1152B have an attached L1 cache 1151 that is specific for each array or shared between the arrays. The cache can be configured as a data cache, an instruction cache, or a single cache that is partitioned to contain data and instructions in different partitions.

In some embodiments, graphics pipeline 1120 includes tessellation components to perform hardware-accelerated tessellation of 3D objects. In some embodiments, a programmable hull shader 1111 configures the tessellation operations. A programmable domain shader 1117 provides back-end evaluation of tessellation output. A tessellator 1113 operates at the direction of hull shader 1111 and contains special purpose logic to generate a set of detailed geometric objects based on a coarse geometric model that is provided as input to graphics pipeline 1120. In some embodiments, if tessellation is not used, tessellation components 1111, 1113, 1117 can be bypassed.

In some embodiments, complete geometric objects can be processed by a geometry shader 1119 via one or more threads dispatched to execution units 1152A, 1152B, or can proceed directly to the clipper 1129. In some embodiments, the geometry shader operates on entire geometric objects, rather than vertices or patches of vertices as in previous stages of the graphics pipeline. If the tessellation is disabled the geometry shader 1119 receives input from the vertex shader 1107. In some embodiments, geometry shader 1119 is programmable by a geometry shader program to perform geometry tessellation if the tessellation units are disabled.

Before rasterization, a clipper 1129 processes vertex data. The clipper 1129 may be a fixed function clipper or a programmable clipper having clipping and geometry shader functions. In some embodiments, a rasterizer/depth 1173 in the render output pipeline 1170 dispatches pixel shaders to convert the geometric objects into their per pixel representations. In some embodiments, pixel shader logic is included in thread execution logic 1150. In some embodiments, an application can bypass the rasterizer 1173 and access un-rasterized vertex data via a stream out unit 1123.

The graphics processor 1100 has an interconnect bus, interconnect fabric, or some other interconnect mechanism that allows data and message passing amongst the major components of the processor. In some embodiments, execution units 1152A, 1152B and associated cache(s) 1151, texture and media sampler 1154, and texture/sampler cache 1158 interconnect via a data port 1156 to perform memory access and communicate with render output pipeline components of the processor. In some embodiments, sampler 1154, caches 1151, 1158 and execution units 1152A, 1152B each have separate memory access paths.

In some embodiments, render output pipeline 1170 contains a rasterizer and depth test component 1173 that converts vertex-based objects into an associated pixel-based representation. In some embodiments, the rasterizer logic includes a windower/masker unit to perform fixed function triangle and line rasterization. An associated render cache 1178 and depth cache 1179 are also available in some embodiments. A pixel operations component 1177 performs pixel-based operations on the data, though in some instances, pixel operations associated with 2D operations (e.g., bit block image transfers with blending) are performed by the 2D engine 1141, or substituted at display time by the display controller 1143 using overlay display planes. In some embodiments, a shared L3 cache 1175 is available to all graphics components, allowing the sharing of data without the use of main system memory.

In some embodiments, graphics processor media pipeline 1130 includes a media engine 1137 and a video front end 1134. In some embodiments, video front end 1134 receives pipeline commands from the command streamer 1103. In some embodiments, media pipeline 1130 includes a separate command streamer. In some embodiments, video front-end 1134 processes media commands before sending the command to the media engine 1137. In some embodiments, media engine 1137 includes thread spawning functionality to spawn threads for dispatch to thread execution logic 1150 via thread dispatcher 1131.

In some embodiments, graphics processor 1100 includes a display engine 1140. In some embodiments, display engine 1140 is external to processor 1100 and couples with the graphics processor via the ring interconnect 1102, or some other interconnect bus or fabric. In some embodiments, display engine 1140 includes a 2D engine 1141 and a display controller 1143. In some embodiments, display engine 1140 contains special purpose logic capable of operating independently of the 3D pipeline. In some embodiments, display controller 1143 couples with a display device (not shown), which may be a system integrated display device, as in a laptop computer, or an external display device attached via a display device connector.

In some embodiments, graphics pipeline 1120 and media pipeline 1130 are configurable to perform operations based on multiple graphics and media programming interfaces and are not specific to any one application programming interface (API). In some embodiments, driver software for the graphics processor translates API calls that are specific to a particular graphics or media library into commands that can be processed by the graphics processor. In some embodiments, support is provided for the Open Graphics Library (OpenGL) and Open Computing Language (OpenCL) from the Khronos Group, the Direct3D library from the Microsoft Corporation, or support may be provided to both OpenGL and D3D. Support may also be provided for the Open Source Computer Vision Library (OpenCV). A future API with a compatible 3D pipeline would also be supported if a mapping can be made from the pipeline of the future API to the pipeline of the graphics processor.

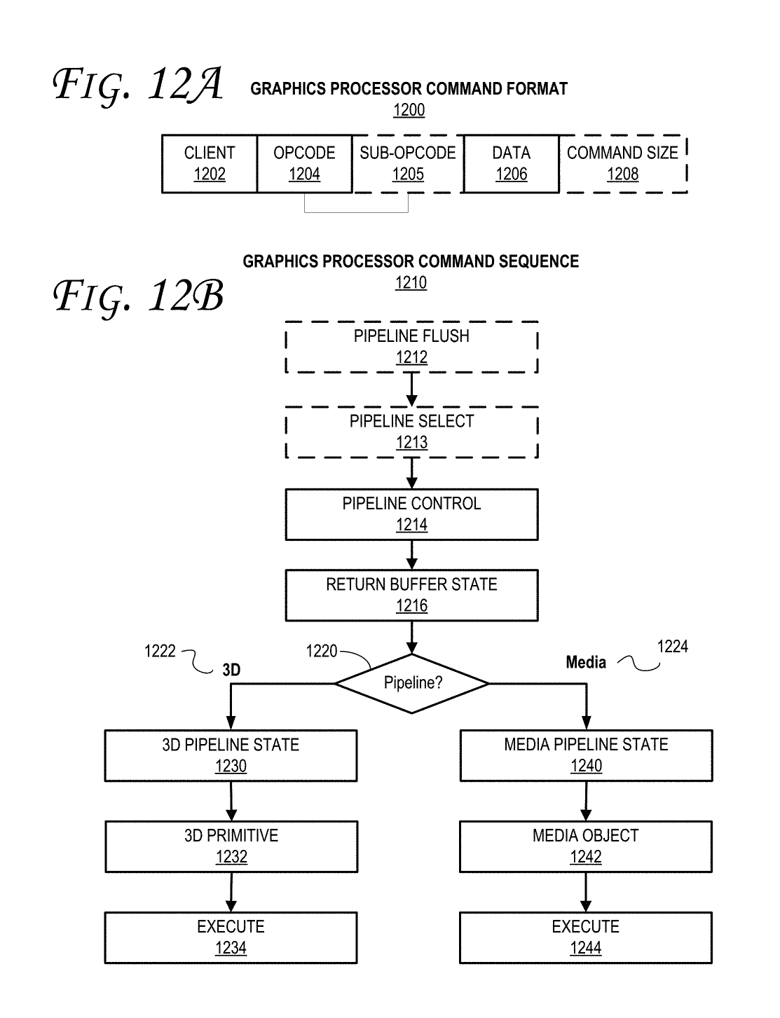

FIG. 12A is a block diagram illustrating a graphics processor command format 1200 according to some embodiments. FIG. 12B is a block diagram illustrating a graphics processor command sequence 1210 according to an embodiment. The solid lined boxes in FIG. 12A illustrate the components that are generally included in a graphics command while the dashed lines include components that are optional or that are only included in a sub-set of the graphics commands. The exemplary graphics processor command format 1200 of FIG. 12A includes data fields to identify a target client 1202 of the command, a command operation code (opcode) 1204, and the relevant data 1206 for the command. A sub-opcode 1205 and a command size 1208 are also included in some commands.

In some embodiments, client 1202 specifies the client unit of the graphics device that processes the command data. In some embodiments, a graphics processor command parser examines the client field of each command to condition the further processing of the command and route the command data to the appropriate client unit. In some embodiments, the graphics processor client units include a memory interface unit, a render unit, a 2D unit, a 3D unit, and a media unit. Each client unit has a corresponding processing pipeline that processes the commands. Once the command is received by the client unit, the client unit reads the opcode 1204 and, if present, sub-opcode 1205 to determine the operation to perform. The client unit performs the command using information in data field 1206. For some commands an explicit command size 1208 is expected to specify the size of the command. In some embodiments, the command parser automatically determines the size of at least some of the commands based on the command opcode. In some embodiments commands are aligned via multiples of a double word.

The flow diagram in FIG. 12B shows an exemplary graphics processor command sequence 1210. In some embodiments, software or firmware of a data processing system that features an embodiment of a graphics processor uses a version of the command sequence shown to set up, execute, and terminate a set of graphics operations. A sample command sequence is shown and described for purposes of example only as embodiments are not limited to these specific commands or to this command sequence. Moreover, the commands may be issued as batch of commands in a command sequence, such that the graphics processor will process the sequence of commands in at least partially concurrence.

In some embodiments, the graphics processor command sequence 1210 may begin with a pipeline flush command 1212 to cause any active graphics pipeline to complete the currently pending commands for the pipeline. In some embodiments, the 3D pipeline 1222 and the media pipeline 1224 do not operate concurrently. The pipeline flush is performed to cause the active graphics pipeline to complete any pending commands. In response to a pipeline flush, the command parser for the graphics processor will pause command processing until the active drawing engines complete pending operations and the relevant read caches are invalidated. Optionally, any data in the render cache that is marked ‘dirty’ can be flushed to memory. In some embodiments, pipeline flush command 1212 can be used for pipeline synchronization or before placing the graphics processor into a low power state.

In some embodiments, a pipeline select command 1213 is used when a command sequence requires the graphics processor to explicitly switch between pipelines. In some embodiments, a pipeline select command 1213 is required only once within an execution context before issuing pipeline commands unless the context is to issue commands for both pipelines. In some embodiments, a pipeline flush command is 1212 is required immediately before a pipeline switch via the pipeline select command 1213.

In some embodiments, a pipeline control command 1214 configures a graphics pipeline for operation and is used to program the 3D pipeline 1222 and the media pipeline 1224. In some embodiments, pipeline control command 1214 configures the pipeline state for the active pipeline. In one embodiment, the pipeline control command 1214 is used for pipeline synchronization and to clear data from one or more cache memories within the active pipeline before processing a batch of commands.

In some embodiments, return buffer state commands 1216 are used to configure a set of return buffers for the respective pipelines to write data. Some pipeline operations require the allocation, selection, or configuration of one or more return buffers into which the operations write intermediate data during processing. In some embodiments, the graphics processor also uses one or more return buffers to store output data and to perform cross thread communication. In some embodiments, the return buffer state 1216 includes selecting the size and number of return buffers to use for a set of pipeline operations.

The remaining commands in the command sequence differ based on the active pipeline for operations. Based on a pipeline determination 1220, the command sequence is tailored to the 3D pipeline 1222 beginning with the 3D pipeline state 1230, or the media pipeline 1224 beginning at the media pipeline state 1240.

The commands for the 3D pipeline state 1230 include 3D state setting commands for vertex buffer state, vertex element state, constant color state, depth buffer state, and other state variables that are to be configured before 3D primitive commands are processed. The values of these commands are determined at least in part based the particular 3D API in use. In some embodiments, 3D pipeline state 1230 commands are also able to selectively disable or bypass certain pipeline elements if those elements will not be used.

In some embodiments, 3D primitive 1232 command is used to submit 3D primitives to be processed by the 3D pipeline. Commands and associated parameters that are passed to the graphics processor via the 3D primitive 1232 command are forwarded to the vertex fetch function in the graphics pipeline. The vertex fetch function uses the 3D primitive 1232 command data to generate vertex data structures. The vertex data structures are stored in one or more return buffers. In some embodiments, 3D primitive 1232 command is used to perform vertex operations on 3D primitives via vertex shaders. To process vertex shaders, 3D pipeline 1222 dispatches shader execution threads to graphics processor execution units.

In some embodiments, 3D pipeline 1222 is triggered via an execute 1234 command or event. In some embodiments, a register write triggers command execution. In some embodiments execution is triggered via a ‘go’ or ‘kick’ command in the command sequence. In one embodiment command execution is triggered using a pipeline synchronization command to flush the command sequence through the graphics pipeline. The 3D pipeline will perform geometry processing for the 3D primitives. Once operations are complete, the resulting geometric objects are rasterized and the pixel engine colors the resulting pixels. Additional commands to control pixel shading and pixel back end operations may also be included for those operations.

In some embodiments, the graphics processor command sequence 1210 follows the media pipeline 1224 path when performing media operations. In general, the specific use and manner of programming for the media pipeline 1224 depends on the media or compute operations to be performed. Specific media decode operations may be offloaded to the media pipeline during media decode. In some embodiments, the media pipeline can also be bypassed and media decode can be performed in whole or in part using resources provided by one or more general purpose processing cores. In one embodiment, the media pipeline also includes elements for general-purpose graphics processor unit (GPGPU) operations, where the graphics processor is used to perform SIMD vector operations using computational shader programs that are not explicitly related to the rendering of graphics primitives.

In some embodiments, media pipeline 1224 is configured in a similar manner as the 3D pipeline 1222. A set of media pipeline state commands 1240 are dispatched or placed into in a command queue before the media object commands 1242. In some embodiments, media pipeline state commands 1240 include data to configure the media pipeline elements that will be used to process the media objects. This includes data to configure the video decode and video encode logic within the media pipeline, such as encode or decode format. In some embodiments, media pipeline state commands 1240 also support the use one or more pointers to “indirect” state elements that contain a batch of state settings.

In some embodiments, media object commands 1242 supply pointers to media objects for processing by the media pipeline. The media objects include memory buffers containing video data to be processed. In some embodiments, all media pipeline states must be valid before issuing a media object command 1242. Once the pipeline state is configured and media object commands 1242 are queued, the media pipeline 1224 is triggered via an execute command 1244 or an equivalent execute event (e.g., register write). Output from media pipeline 1224 may then be post processed by operations provided by the 3D pipeline 1222 or the media pipeline 1224. In some embodiments, GPGPU operations are configured and executed in a similar manner as media operations.

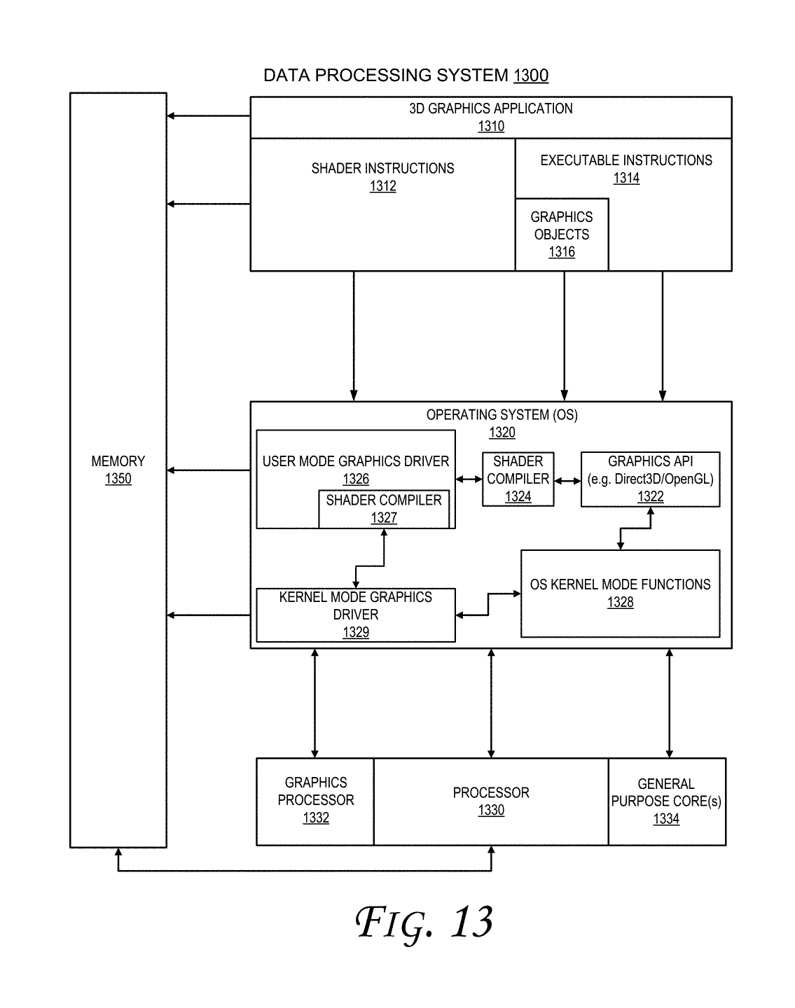

FIG. 13 illustrates exemplary graphics software architecture for a data processing system 1300 according to some embodiments. In some embodiments, software architecture includes a 3D graphics application 1310, an operating system 1320, and at least one processor 1330. In some embodiments, processor 1330 includes a graphics processor 1332 and one or more general-purpose processor core(s) 1334. The graphics application 1310 and operating system 1320 each execute in the system memory 1350 of the data processing system.

In some embodiments, 3D graphics application 1310 contains one or more shader programs including shader instructions 1312. The shader language instructions may be in a high-level shader language, such as the High Level Shader Language (HLSL) or the OpenGL Shader Language (GLSL). The application also includes executable instructions 1314 in a machine language suitable for execution by the general-purpose processor core 1334. The application also includes graphics objects 1316 defined by vertex data.

In some embodiments, operating system 1320 is a Microsoft® Windows® operating system from the Microsoft Corporation, a proprietary UNIX-like operating system, or an open source UNIX-like operating system using a variant of the Linux kernel. When the Direct3D API is in use, the operating system 1320 uses a front-end shader compiler 1324 to compile any shader instructions 1312 in HLSL into a lower-level shader language. The compilation may be a just-in-time (JIT) compilation or the application can perform shader pre-compilation. In some embodiments, high-level shaders are compiled into low-level shaders during the compilation of the 3D graphics application 1310.

In some embodiments, user mode graphics driver 1326 contains a back-end shader compiler 1327 to convert the shader instructions 1312 into a hardware specific representation. When the OpenGL API is in use, shader instructions 1312 in the GLSL high-level language are passed to a user mode graphics driver 1326 for compilation. In some embodiments, user mode graphics driver 1326 uses operating system kernel mode functions 1328 to communicate with a kernel mode graphics driver 1329. In some embodiments, kernel mode graphics driver 1329 communicates with graphics processor 1332 to dispatch commands and instructions.

One or more aspects of at least one embodiment may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the embodiments described herein.

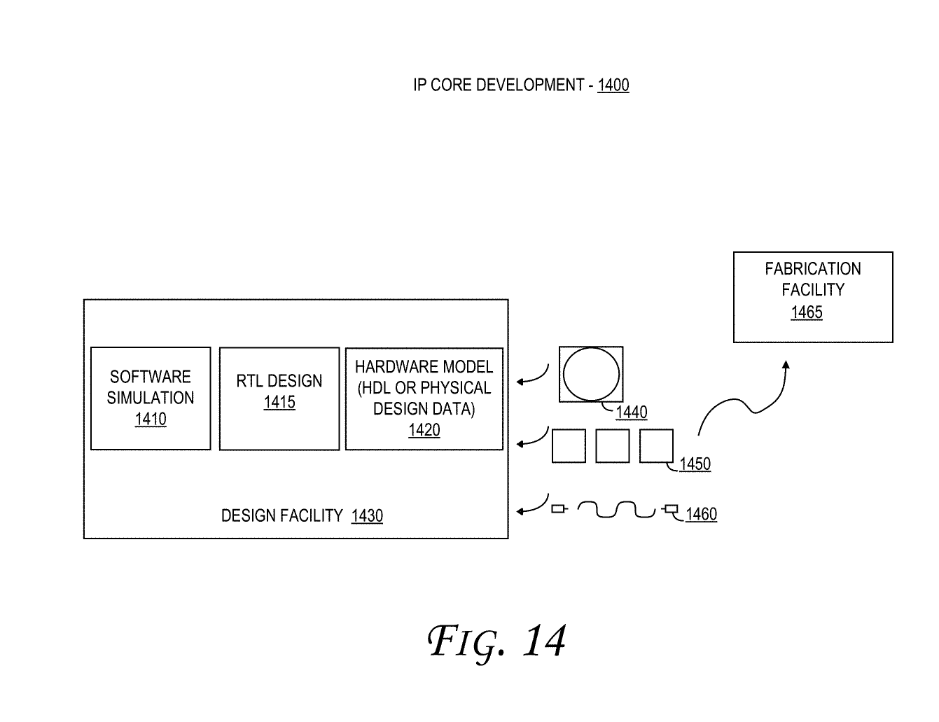

FIG. 14 is a block diagram illustrating an IP core development system 1400 that may be used to manufacture an integrated circuit to perform operations according to an embodiment. The IP core development system 1400 may be used to generate modular, re-usable designs that can be incorporated into a larger design or used to construct an entire integrated circuit (e.g., an SOC integrated circuit). A design facility 1430 can generate a software simulation 1410 of an IP core design in a high level programming language (e.g., C/C++). The software simulation 1410 can be used to design, test, and verify the behavior of the IP core. A register transfer level (RTL) design can then be created or synthesized from the simulation model 1400. The RTL design 1415 is an abstraction of the behavior of the integrated circuit that models the flow of digital signals between hardware registers, including the associated logic performed using the modeled digital signals. In addition to an RTL design 1415, lower-level designs at the logic level or transistor level may also be created, designed, or synthesized. Thus, the particular details of the initial design and simulation may vary.

The RTL design 1415 or equivalent may be further synthesized by the design facility into a hardware model 1420, which may be in a hardware description language (HDL), or some other representation of physical design data. The HDL may be further simulated or tested to verify the IP core design. The IP core design can be stored for delivery to a 3rd party fabrication facility 1465 using non-volatile memory 1440 (e.g., hard disk, flash memory, or any non-volatile storage medium). Alternatively, the IP core design may be transmitted (e.g., via the Internet) over a wired connection 1450 or wireless connection 1460. The fabrication facility 1465 may then fabricate an integrated circuit that is based at least in part on the IP core design. The fabricated integrated circuit can be configured to perform operations in accordance with at least one embodiment described herein.

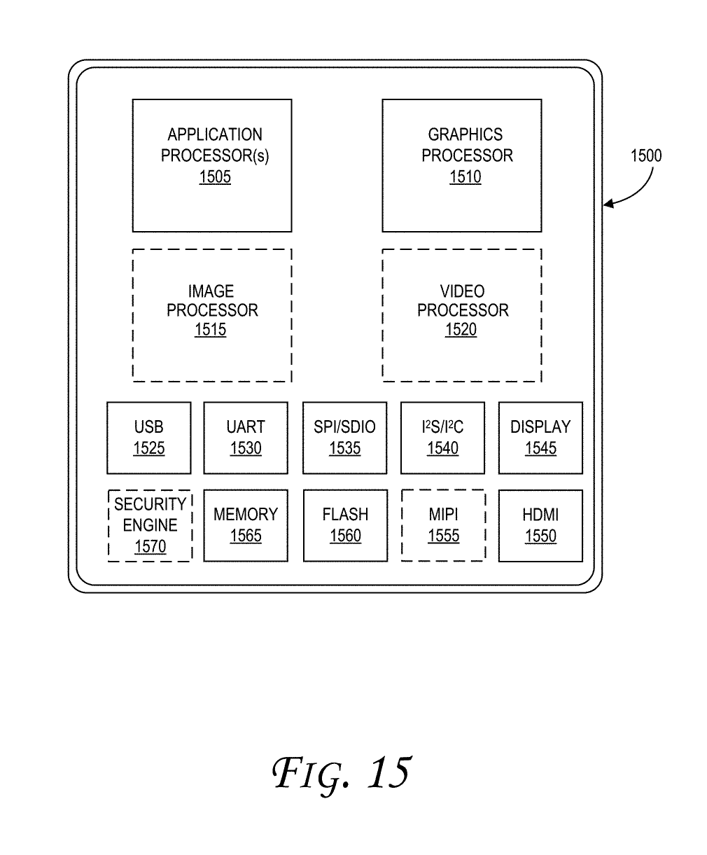

FIG. 15 is a block diagram illustrating an exemplary system on a chip integrated circuit 1500 that may be fabricated using one or more IP cores, according to an embodiment. The exemplary integrated circuit includes one or more application processors 1505 (e.g., CPUs), at least one graphics processor 1510, and may additionally include an image processor 1515 and/or a video processor 1520, any of which may be a modular IP core from the same or multiple different design facilities. The integrated circuit includes peripheral or bus logic including a USB controller 1525, UART controller 1530, an SPI/SDIO controller 1535, and an I2S/I2C controller 1540. Additionally, the integrated circuit can include a display device 1545 coupled to one or more of a high-definition multimedia interface (HDMI) controller 1550 and a mobile industry processor interface (MIPI) display interface 1555. Storage may be provided by a flash memory subsystem 1560 including flash memory and a flash memory controller. Memory interface may be provided via a memory controller 1565 for access to SDRAM or SRAM memory devices. Some integrated circuits additionally include an embedded security engine 1570.

Additionally, other logic and circuits may be included in the processor of integrated circuit 1500, including additional graphics processors/cores, peripheral interface controllers, or general purpose processor cores.

The following examples pertain to further embodiments. Example 1 may optionally include an apparatus comprising: memory to store one or more queues; and logic, coupled to the memory, to access the one or more queues out-of-order to increase utilization of a processor to perform a plurality of tasks corresponding to a workload based at least in part on: characteristics of the workload, resources needed to complete the workload, and potential for introduction of a bubble in a pipeline of the processor. Example 2 may optionally include the apparatus of example 1, wherein the bubble is to comprise a condition where at least a portion of the processor pipeline is underutilized or unutilized. Example 3 may optionally include the apparatus of example 2, wherein the portion of the processor pipeline is to comprise an execution unit. Example 4 may optionally include the apparatus of example 1, wherein the logic is to cause scheduling of execution of two or more tasks from the plurality of tasks simultaneously, wherein the two or more tasks were to execute independently prior to the logic causing a change to the scheduling of the execution of the two or more tasks. Example 5 may optionally include the apparatus of example 4, comprising logic to remove serialization events corresponding to the two or more tasks, wherein the serialization events are to be based on one or more dependencies of the two or more tasks. Example 6 may optionally include the apparatus of example 1, comprising logic to defer heap allocation operations in response to a determination that at least one of the plurality of tasks is to access a heap block. Example 7 may optionally include the apparatus of example 1, wherein the characteristics of the workload is to comprise a number of threads needed to complete the workload. Example 8 may optionally include the apparatus of example 1, wherein the logic is to comprise a device driver. Example 9 may optionally include the apparatus of example 1, wherein the logic is to comprise an OpenCL™ device driver, an OpenGL® device driver, or a DirectX® device driver. Example 10 may optionally include the apparatus of example 1, wherein the processor is to comprise one or more processor cores. Example 11 may optionally include the apparatus of example 1, wherein the processor is to comprise a GPU (Graphics Processing Unit). Example 12 may optionally include the apparatus of example 11, wherein the GPU is to comprise one or more cores. Example 13 may optionally include the apparatus of example 1, wherein one or more of the processor, having one or more processor cores, the memory, and the logic are on a same integrated circuit die.

Example 14 may optionally include a method comprising: storing one or more queues in memory; and accessing the one or more queues out-of-order to increase utilization of a processor to perform a plurality of tasks corresponding to a workload based at least in part on: characteristics of the workload, resources needed to complete the workload, and potential for introduction of a bubble in a pipeline of the processor. Example 15 may optionally include the method of example 14, wherein the bubble comprises a condition where at least a portion of the processor pipeline is underutilized or unutilized. Example 16 may optionally include the method of example 15, wherein the portion of the processor pipeline comprises an execution unit. Example 17 may optionally include the method of example 14, further comprising causing scheduling of execution of two or more tasks from the plurality of tasks simultaneously, wherein the two or more tasks were to execute independently prior to the causing a change to the scheduling of the execution of the two or more tasks. Example 18 may optionally include the method of example 17, further comprising removing serialization events corresponding to the two or more tasks, wherein the serialization events are based on one or more dependencies of the two or more tasks. Example 19 may optionally include the method of example 14, further comprising deferring heap allocation operations in response to a determination that at least one of the plurality of tasks is to access a heap block. Example 20 may optionally include the method of example 14, wherein the characteristics of the workload is to comprise a number of threads needed to complete the workload. Example 21 may optionally include the method of example 14, wherein the accessing is performed by a device driver. Example 22 may optionally include the method of example 14, wherein the accessing is performed by: an OpenCL™ device driver, an OpenGL® device driver, or a DirectX® device driver.

Example 23 may optionally include one or more computer-readable medium comprising one or more instructions that when executed on at least one processor configure the at least one processor to perform one or more operations to: store one or more queues in memory; and access the one or more queues out-of-order to increase utilization of a processor to perform a plurality of tasks corresponding to a workload based at least in part on: characteristics of the workload, resources needed to complete the workload, and potential for introduction of a bubble in a pipeline of the processor. Example 24 may optionally include the one or more computer-readable medium of example 23, further comprising one or more instructions that when executed on the at least one processor configure the at least one processor to perform one or more operations to cause scheduling of execution of two or more tasks from the plurality of tasks simultaneously, wherein the two or more tasks were to execute independently prior to the causing a change to the scheduling of the execution of the two or more tasks. Example 25 may optionally include the one or more computer-readable medium of example 23, further comprising one or more instructions that when executed on the at least one processor configure the at least one processor to perform one or more operations to cause removal of serialization events corresponding to the two or more tasks, wherein the serialization events are based on one or more dependencies of the two or more tasks. Example 26 may optionally include the one or more computer-readable medium of example 23, wherein the bubble comprises a condition where at least a portion of the processor pipeline is underutilized or unutilized. Example 27 may optionally include the one or more computer-readable medium of example 26, wherein the portion of the processor pipeline comprises an execution unit. Example 28 may optionally include the one or more computer-readable medium of example 23, further comprising one or more instructions that when executed on the at least one processor configure the at least one processor to perform one or more operations to cause deferral of heap allocation operations in response to a determination that at least one of the plurality of tasks is to access a heap block.

Example 29 may optionally include an apparatus comprising means to perform a method as set forth in any preceding example. Example 30 comprises machine-readable storage including machine-readable instructions, when executed, to implement a method or realize an apparatus as set forth in any preceding example.

In various embodiments, the operations discussed herein, e.g., with reference to FIGS. 1-15, may be implemented as hardware (e.g., logic circuitry), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIGS. 1-15.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
memory to store one or more queues; and
logic, coupled to the memory, to access the one or more queues out-of-order to increase utilization of a processor to perform a plurality of tasks corresponding to a workload based at least in part on: characteristics of the workload, resources needed to complete the workload, and potential for introduction of a bubble in a pipeline of the processor.

2. The apparatus of claim 1, wherein the bubble is to comprise a condition where at least a portion of the processor pipeline is underutilized or unutilized.

3. The apparatus of claim 2, wherein the portion of the processor pipeline is to comprise an execution unit.

4. The apparatus of claim 1, wherein the logic is to cause scheduling of execution of two or more tasks from the plurality of tasks simultaneously, wherein the two or more tasks were to execute independently prior to the logic causing a change to the scheduling of the execution of the two or more tasks.

5. The apparatus of claim 4, comprising logic to remove serialization events corresponding to the two or more tasks, wherein the serialization events are to be based on one or more dependencies of the two or more tasks.

6. The apparatus of claim 1, comprising logic to defer heap allocation operations in response to a determination that at least one of the plurality of tasks is to access a heap block.

7. The apparatus of claim 1, wherein the characteristics of the workload is to comprise a number of threads needed to complete the workload.

8. The apparatus of claim 1, wherein the logic is to comprise a device driver.

9. The apparatus of claim 1, wherein the logic is to comprise an OpenCL™ device driver, an OpenGL® device driver, or a DirectX® device driver.

10. The apparatus of claim 1, wherein the processor is to comprise one or more processor cores.

11. The apparatus of claim 1, wherein the processor is to comprise a GPU (Graphics Processing Unit).

12. The apparatus of claim 11, wherein the GPU is to comprise one or more cores.

13. The apparatus of claim 1, wherein one or more of the processor, having one or more processor cores, the memory, and the logic are on a same integrated circuit die.

14. A method comprising:
storing one or more queues in memory; and
accessing the one or more queues out-of-order to increase utilization of a processor to perform a plurality of tasks corresponding to a workload based at least in part on: characteristics of the workload, resources needed to complete the workload, and potential for introduction of a bubble in a pipeline of the processor.

15. The method of claim 14, wherein the bubble comprises a condition where at least a portion of the processor pipeline is underutilized or unutilized.

16. The method of claim 15, wherein the portion of the processor pipeline comprises an execution unit.

17. The method of claim 14, further comprising causing scheduling of execution of two or more tasks from the plurality of tasks simultaneously, wherein the two or more tasks were to execute independently prior to the causing a change to the scheduling of the execution of the two or more tasks.

18. The method of claim 17, further comprising removing serialization events corresponding to the two or more tasks, wherein the serialization events are based on one or more dependencies of the two or more tasks.

19. The method of claim 14, further comprising deferring heap allocation operations in response to a determination that at least one of the plurality of tasks is to access a heap block.

20. The method of claim 14, wherein the characteristics of the workload is to comprise a number of threads needed to complete the workload.

21. The method of claim 14, wherein the accessing is performed by a device driver.

22. The method of claim 14, wherein the accessing is performed by: an OpenCL™ device driver, an OpenGL® device driver, or a DirectX® device driver.

23. One or more computer-readable medium comprising one or more instructions that when executed on at least one processor configure the at least one processor to perform one or more operations to:
store one or more queues in memory; and
access the one or more queues out-of-order to increase utilization of a processor to perform a plurality of tasks corresponding to a workload based at least in part on: characteristics of the workload, resources needed to complete the workload, and potential for introduction of a bubble in a pipeline of the processor.

24. The one or more computer-readable medium of claim 23, further comprising one or more instructions that when executed on the at least one processor configure the at least one processor to perform one or more operations to cause scheduling of execution of two or more tasks from the plurality of tasks simultaneously, wherein the two or more tasks were to execute independently prior to the causing a change to the scheduling of the execution of the two or more tasks.

25. The one or more computer-readable medium of claim 23, further comprising one or more instructions that when executed on the at least one processor configure the at least one processor to perform one or more operations to cause removal of serialization events corresponding to the two or more tasks, wherein the serialization events are based on one or more dependencies of the two or more tasks.
